(19) United States
(12) Patent Application Publication
(10) Pub. No.: US 2026/0285716 A1
(43) Pub. Date: Sep. 24, 2026

(54) METHODS TO REDUCE CONTAMINATION, BIOFILM, AND FOULING FROM WATER SYSTEMS AND SURFACES

(71) Applicant: Aequor Inc., Encinitas, CA (US)

(72) Inventor: Cynthia K. Burzell, Encinitas, CA (US)

(73) Assignee: Aequor Inc., Encinitas, CA (US)

(21) Appl. No.: 18/877,848

(22) PCT Filed: Jun. 21, 2023
(86) PCT No.: PCT/US2023/068773

§ 371 Date: Dec. 20, 2024

Related U.S. Application Data
(60) Provisional application No. 63/366,749, filed on Jun. 21, 2022.

(51) Int. Cl. C02F 1/50; C02F 103/36

(52) U.S. Cl. CPC C02F 1/50; C02F 2103/365; C02F 2303/04; C02F 2303/20

(57) ABSTRACT

The present disclosure describes compositions comprising one or more organophosphorous or organosulfurous compounds for treating produced water. The compositions prevent the formation of biofilm, prevent fouling, and/or kill microbes in produced water, and further comprise one or more surfactants, solvents, antimicrobial agents, antifoaming agents, preservatives, pH adjusters, agents providing scent. Further disclosed a method of treating produced water, comprising applying the composition to the produced water.

### CROSS REFERENCE TO RELATED APPLICATIONS

This application claims the benefit of U.S. Provisional Application No. 63/366,749 filed Jun. 21, 2022, which is incorporated herein by reference in its entirety.

### FIELD OF DISCLOSURE

This disclosure relates to organophosphorus and organosulfurous compounds and compositions thereof, and methods of using them in various applications.

### BACKGROUND

Microbial growth and fouling on surfaces and in water cause contamination and operational inefficiencies, and can result in human illnesses. Microbial contamination and/or fouling are problematic in processing industries. Contamination may consist of biological, chemical, or physical substances in contact with surfaces, water, and filters.

Fouling may consist of both “microfouling” and “macrofouling.” Microfouling is the attachment of microorganisms such as bacteria, yeast, fungi, and microalgae on surfaces to form biofilm or to each other to form clumps. Microfouling causes corrosion, scale, slime, clogging, and clumping. Macrofouling is the attachment of foulers which are eukaryotes such as, barnacles, mussels, and algae to surfaces. Macrofouling forms on the outside of underwater structures, pipelines, and ship hulls, and on the inside of ballast tanks, intake pipes used to carry water to cooling towers of all traditional and renewable energy plants, etc. Fouling results in operational inefficiencies and increased costs, including frequent replacement of degraded and fouled equipment, operational downtime and labor costs to apply treatments and remedies, and increased fuel consumption by over 50% (with the corresponding greenhouse gas emissions) to overcome clogging and hydrodynamic drag.

Another problem related to contamination and fouling occurs in oil refining and desalination processes that produce a large amount of waste termed “process water.” In oilfields and refineries, the term “produced water” is used to describe water that is brought to the surface from underground as a byproduct during the extraction of oil and gas. Produced water is a mixture of dissolved and particulate inorganic and organic matters ranging from near freshwater to concentrated saline brine, and can also be called “brine”, “saltwater”, or “formation water.” The physical and chemical properties of produced water vary depending on the geographic location and the type of hydrocarbon product being produced.

The treatment of produced water is challenging because of the presence of several contaminants such as heavy metals, dissolved organic compounds, and biological contaminants. They cannot be removed by conventional equipment and may be a threat to the environment when discarded.

Another problem related to contamination and fouling occurs in wastewater and ground water systems and their filtration systems. Wastewater treatment processes remove contaminants from wastewater and convert it into an effluent that can be returned to the water cycle. Groundwater is treated by pumping the water to the surface and treating the water with a filtration system to remove contaminants. The treatment of wastewater and groundwater is challenging because of microfouling and macrofouling contaminating the filters.

### SUMMARY OF THE DISCLOSURE

Provided herein are methods for treating or inhibiting contamination in produced water, surfaces, and/or filters, the methods comprising administrating a composition in an effective amount comprising one or more of an organophosphorous compound and organosulfurous compound and/or antimicrobial, surfactant, and/or sonication. The present invention involves a novel solution for the problem presented above and is directed to a composition that effectively cleans, disperses, and/or treats contamination. Thus, someone skilled in the art, using the compositions of the present invention can avoid problems associated with biofilm and fouling.

The compounds and/or compositions described herein include one or more organophosphorous and/or organosulfurous compounds, one or more derivatives thereof, or one or more salts, acids, bases, hydrates, or solvates thereof (of the organophosphorous compounds, organosulfurous compounds, or derivatives thereof). In embodiments, the one or more organophosphorous or organosulfurous compounds are described below. The compositions described herein further include one or more antimicrobial agents, antibiofilm agents, surfactants, antifoaming agents, preservatives, agents providing scent, solvents, or a combination.

In embodiments, the composition acts as a cleaning agent, dispersant, surfactant, and/or biofilm removal and/or prevention agent, anti-biofilm, antifouling, antimicrobial, antifungal, and/or agent against other organisms.

In embodiments, the composition is a formulation to be added to a solution, including water, a filter, or the like. The composition can be formulated on a wetted surface, including in a coating, paint, chemically bound material, or the like. The composition can also be formulated with nanotechnology. In embodiments, the composition is formulated with controlled-release technology. The composition is comprised of polymeric material. The composition is comprised in water filters, including activated carbon filters, reverse osmosis, UV filters, desalination filters, plant filters, media filters, or the like.

In embodiments, the composition is in an automatic or manually operated dispenser. In embodiments, the dispenser dispenses the composition on a surface or in water. In embodiments, the dispenser is for a handrail for a moving walkway or escalator.

In embodiments, the compositions described herein remove contaminants and/or improves the removal of contaminants. The contaminants can be in the water, on the surface of water, any wet surface, or on industrial or household surfaces, including apparatuses (such as medical devices), counters, and other hard and soft surfaces. Examples of contaminants include microorganisms, salt, soil, dirt, suspended solids, hydrocarbons, biofilms, metals, scale deposits, toxins, chemicals such as chemical additives injected into the well to facilitate extraction, and a combination thereof. In embodiments, the compositions described herein remove contaminants from produced water.

In embodiments, the contaminants include one or more bacteria, including waterborne bacteria, such as Sulfate Reducing Bacteria (SRB), Campylobacter jejuni, Escherichia coli, Giardia lambia, Hepatitis A, Legionaella pneumophila, Salmonella enterica, and others, as well as Staphylococcus aureus, Staphylococcus epidermidis, Acinetobacter baumannii, Pseudomonas aeruginosa, Enterobacteriaceae, Salmonella bongori, Enterococcus faecium, Helicobacter pylon, Campylobacter spp., Neisseria gonorrhoeae, Streptococcus pneumoniae, Streptococcus mutans, Streptococcus gordonii, Streptococcus pyogenes, Haemophilus influenzae, Shigella spp., Klebsiella pneumoniae, Clostridium difficile, Bacillus anthracis, Yersinia pestis, Francisella tularensis, Burkholderia mallei, Burkholderia pseudomallei, Corynebacterium spp., Micrococcus luteus, Micrococcus lylae, Micrococcus roseus, Cutibaceterium acnes, Vibrio vulnificus, Vibrio cholerae, Vibrio parahaemolyticus, Propionibacterium acnes, Neisseria gonorrhoeae, Burkholderia cepacia, Burkholderia mallei, Burkholderia pseudomallei, Ralstonia pickettii, Cuprividus metalliduran, and/or biofilm-forming bacteria found on aquatic surfaces, including Cobetia marina and others.

In embodiments, the eukaryotic fouling contaminations are caused by algae and microalgae, including Euglenophyta, Chrysophyta, Pyrrophyta, Chlorophyta, Rhodophyta, Paeophyta, and/or Xanthophyta, plants, including sea grasses; and animals, including tunicates, mussels, oysters, clams, barnacles, cnidarians, sponges, and larvae. In embodiments, the fungal contamination is caused by fungi, including Zygomycota, Ascomycota, Basidiomycota, Deuteromycota, and others, and/or other eukaryotic foulers.

In embodiments, the organophosphorous or organosulfurous compounds are sodium dodecylbenzenesulfonate (SDBS), sodium dodecyl sulfate (SDS), 4-Dodecylbenzenesulfonic acid (DBSA), butyl phosphoramidate (BPA), (4-aminophenetyl) dimethylphosphine oxide (APDMPO), dibutyl phosphate (DBP), and/or dibutyl phosphite (DBPT).

In embodiments, the organophosphorous and/or organosulfurous compounds are present in the composition at a concentration of between 0.00001% to 5.0%.

In embodiments, the antimicrobial agent may be oxidizing (halogenated, non-halogenated, and acid) biocides, metals (ionic or salts), and/or non-oxidizing biocides, ozonated water, acids, naturally-occurring biocides such as chitosan, and/or plant derived compounds. In embodiments the biocides include but are not limited to, chlorine (free chlorine, hypochlorous acid, hypochlorite salts), chlorine dioxide, sodium chloride, bromine, iodine, hydrogen peroxide, chlorhexidine, bismuth thiols (e.g, bismuth ethanedithiol), potassium permanganate, peracetic acid, propionic salts, parabens, 2-(Decylthio)ethanamine (DTEA), glutaraldehyde, ortho-phthalaldehyde, tetrakish(hydroxymethyl)phosphonium sulfate (THPS), tributyltetradecylphosphonium chloride (TTPC), 2-Bromo-4-hydroxyacetopne (BHAP), 2-Bromo-2-nitropropane-1,3-diol (Bronopol), sodium dimethyldithiocarbamate (DIBAM), disodium ethylene bisdithiocarbamate (NIBAM), potassium n-hydroxymethyl-n-methyldithiocarbamate, 2,2 Dihydroxy-5,5-dichlorodiphenyl monosulfide (Chlorothioether), 2-2-Dibromo-3-nitrilopropionamide (DBNPA), methylene bis(thiocyanate) (MBT), polyquats (e.g., poly[oxyethylene (dimethyliminio)ethylene,dichloride]), quaternary ammonium compound (Quats) (e.g., alkyldimethylbenzylammonium chloride, ADBACs), sulfone (e.g., Bis(trichloromethyl) sulfone), bis(tributyltin) oxide (TBTO), 2-(tert-butylamino)-4-chloro-6-(ethylamino)-s-triazine (TBZ), tetrachloro-2,4,6-cyano-3-benzonitrile (TCCBN), 2(thiocyanomethylthio)benzothiazole (TCMTB), tetrahydro-3,5,dimethyl-2H-1,3,5-thiadiazine-2-thione, isothiazolines including chloromethylisothiazolinone (CMIT), methylisothiazolinone (MIT), and 1,2-benzisothiazolin-3-one (BIT), guanides, including, guanidine and biguanides (e.g., dodecylguanidine hydrochloride and acetate, polyhexamethylene biguanide hydrochloride, and/or tetradecylguanidine. In embodiments, the concentration of biocide is a final concentration of between 0.01% to 5%. In embodiments, the concentration of chlorine is a concentration of between 0.1 ppm to 50 ppm. In embodiments, the metals include but are not limited to silver, copper, aluminum, gold, zinc, bronze, brass, and tin, and their derivatives. In embodiments, the silver compound is silver ions, silver particles, silver nanoparticles, metallic silver, colloidal silver, silver sulfate, or silver chloride. In embodiments, the concentration of the silver is a concentration of between 0.01 ppm to 30 ppm. In embodiments, the zinc compound includes, zinc acetate, zinc octoate, zinc pyrithione, zinc sulfate, and/or zinc oxide. In embodiments, the concentration of the zinc is a final concentration of between 0.01% to 5%. In embodiments, the concentration of chitosan is a concentration of between 0.01% to 5%. In embodiments, the concentration of acid is a concentration of between 0.01% to 5%. In embodiments, the plant derived compound includes orange essential oil, lemon essential oil, oregano essential oil, thyme essential oil, cinnamon essential oil, citral, cinnamaldehyde, carvacrol, thymol, citric acid, itaconic acid, aconitic acid, isocitric acid, succinic acid, fumaric acid, malic acid, glyoxylic acid, pyruvic acid, 2-oxoglutaric acid, 2-phosphoenolpyruvic acid, phosphoenolpyruvate carboxylase, and/or aloe. In embodiments, the concentration of the plant derived compound is a concentration of between 0.01% to 5%. In embodiments, the acid is maleic acid, clavulanic acid, glucaric acid, formic acid, carboxylic acid, hypochlorous acid, and/or hydrochloric acid. In embodiments, the concentration of acid is a concentration of between 0.001% to 5%.

In embodiments, the organophosphorous or organosulfurous compounds and/or antimicrobials are used with sonication. In embodiments, the compounds are used with a sonicating brush. In embodiments, the compounds are used after a surface is treated with sonication. In embodiments, the ultrasonic frequency is 20 kHz to 40 kHz.

Further provided herein is a method of preventing and/or removing microorganisms and other contaminants in water, on the surface of water, or industrial or household surfaces, the method comprising contacting a surface with a composition described herein in an effective amount comprising one or more of an organophosphorous compound, organosulfurous compound, and antimicrobial.

In embodiments, the composition is a cleaning agent, dispersant, surfactant, wetting agent, wet edge enhancer, compatibilizer; and/or anti-odor agent, agent to disrupt, remove, prevent and/or inhibit biofilm; agent to disrupt, remove, prevent and/or remove fouling; agent to disrupt, remove, prevent, and/or inhibit microbial growth and kill microorganisms, including bacteria, fungi, viruses, and other microorganisms.

In embodiments, the composition consists of an antifoam agent. In embodiments, the antifoam agent is silicone based, non-silicone based, and/or polyurethane dispersions. In embodiments, the antifoam agent includes but is not limited to, SE-15, SAG 710, Silwet DA-33, SagTex DSA. SE-15 contains 10% active silicon and non-ionic emulsifiers. In embodiments, the concentration of the antifoam agent is a final concentration of between 0.001% to 1%.

The present disclosure describes a method of using the organophosphorous and/or organosulfurous compounds in combination with natural and/or synthesized water-borne, oil-borne, or light organic solvent chemical preservatives to increase the durability and resistance of wood, timber, wood structures, or engineered lumber from being destroyed by insects, fungi, other microorganisms, and/or climate and surrounding elements, etc. Application processes include pressure processes, non-pressure processes, such as spraying, soaking, dipping, bathing, brush and spray treatments, steeping, etc., and other processes and treatments.

The present disclosure also describes a method to prevent soil, microfouling, and contamination when present on surfaces and/or embedded in or coated on rubber, plastic, silicone, metal, glass, or other surfaces. In embodiments, the agent is incorporated in Oomoo 25 and Oomoo 30 silicone rubber compound (Smooth-On) and Smooth-Cast liquid plastic compound (Smooth-On) per the manufacturer's instructions. In embodiments, the coating on pipes for a water system.

Moreover, the present disclosure describes a method to clean, decontaminate, and descale equipment, appliances and parts, and devices including but not limited to washing machines, refrigerators, dishwashers, coffee makers, and water purifiers. In embodiments, the agent cleans and descales the water systems in a refrigerator, coffee maker, water purifier, water dispenser, fountain, and irrigation system.

### DETAILED DESCRIPTION

This disclosure relates to organophosphorous and organosulfurous compounds and their use in the prevention or treatment of microbial contamination and fouling. The disclosure also relates to combination therapy using a composition comprising organophosphorous compounds, organosulfurous compounds and/or antimicrobial, and/or sonication in methods for treating or inhibiting microbial contamination and fouling in water, on wetted surfaces, and consumer and industrial surfaces.

All publications and patent applications herein are incorporated by reference to the same extent as if each individual publication or patent application was specifically and individually indicated to be incorporated by reference.

As used herein, the term “or” is understood to be inclusive unless specifically stated or obvious from context to the contrary. As used herein, the terms “a”, “an”, and “the” are understood to be singular or plural unless specifically stated or obvious from context to the contrary.

Furthermore, “and/or” where used herein is to be taken as specific disclosure of each of the two or more specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; and A (alone); B (alone); and C (alone).

As used herein, the term “antimicrobial” refers to a substance that destroys or inhibits the growth of microorganisms. As used herein, the term “antifouling” refers to a substance that destroys or inhibits the growth of foulers.

The term “heteroatom” refers to any atom other than carbon, for example, N, O, or S.

The term “substituents” refers to groups such as hydroxy, alkoxy, mercapto, cycloalkyl, substituted cycloalkyl, heterocyclic, substituted heterocyclic, aryl, substituted aryl, heteroaryl, substituted heteroaryl, aryloxy, substituted aryloxy, halogen, cyano, nitro, amino, amido, aldehyde, acyl, oxyacyl, carboxyl, sulfonyl, sulfonamide, sulfuryl, and the like.

The term “hydrocarbyl” refers to univalent groups formed by removing a hydrogen atom from a hydrocarbon, e.g. alkyl, cycloalkyl, alkenyl, alkynyl, aryl, alkylaryl, arylalkyl, arylalkenyl, arylalkynyl, and arylene. The term “substituted hydrocarbyl” refers to hydrocarbyl groups further bearing one or more substituents as defined herein.

The term “alkyl” refers to a monovalent straight or branched chain hydrocarbon group having from one to 12 carbon atoms, for example, methyl, ethyl, n-propyl, iso-propyl, n-butyl, iso-butyl, tert-butyl, n-pentyl (also known as n-amyl), n-hexyl, and the like. The term “substituted alkyl” refers to alkyl groups further bearing one or more substituents as defined herein.

The term “alkenyl” refers to straight-chained or branched hydrocarbyl groups having at least one carbon-carbon double bond and having 2 to 12 carbon atoms, and the term “substituted alkenyl” refers to alkenyl groups further bearing one or more substituents as defined herein.

The term “alkynyl” refers to straight-chained or branched hydrocarbyl groups having at least one carbon-carbon triple bond, and having 2 to 12 carbon atoms, and the term “substituted alkynyl” refers to alkynyl groups further bearing one or more substituents as defined herein.

The term “alkoxy” refers to the moiety —O-alkyl, wherein alkyl is as defined above, and the term “substituted alkoxy” refers to alkoxy groups further bearing one or more substituents as defined herein.

The term “cycloalkyl” refers to alkyl groups having 3 and 8 carbon atoms arranged as a ring, and the term “substituted cycloalkyl” refers to cycloalkyl groups further bearing one or more substituents as defined herein.

The term “aromatic” refers to a cyclically conjugated molecular entity with a stability, due to derealization, significantly greater than that of a hypothetical localized structure, such as the Kekule structure.

The term “heterocyclic,” when used to describe an aromatic ring, refers to the aromatic rings containing at least one heteroatom, as defined above. The term “heterocyclic,” when not used to describe an aromatic ring, refers to cyclic (i.e., ring-containing) groups other than aromatic groups, the cyclic group being formed by 3 and 14 carbon atoms and at least one heteroatom as defined herein.

The term “substituted heterocyclic” refers, for both aromatic and non-aromatic structures, to heterocyclic groups further bearing one or more substituents as defined herein.

The term “aryl” refers to aromatic groups having 5 to 14 carbon atoms and the term “substituted aryl” refers to aryl groups further bearing one or more substituents as defined herein.

The term “heteroaryl” refers to aromatic rings, where the ring structure is formed by 3 to 14 carbon atoms and by at least one heteroatom described above, and the term “substituted heteroaryl” refers to heteroaryl groups further bearing one or more substituents as defined herein.

The term “alkylaryl” refers to alkyl-substituted aryl groups and the term “substituted alkylaryl” refers to alkylaryl groups further bearing one or more substituents as defined herein.

The term “arylalkyl” refers to aryl-substituted alkyl groups and the term “substituted arylalkyl” refers to arylalkyl groups further bearing one or more substituents as defined herein.

The term “arylalkenyl” refers to aryl-substituted alkenyl groups and the term “substituted arylalkenyl” refers to arylalkenyl groups further bearing one or more substituents as defined herein.

The term “arylalkynyl” refers to aryl-substituted alkynyl groups and the term “substituted arylalkynyl” refers to arylalkynyl groups further bearing one or more substituents as defined herein.

The term “arylene” refers to divalent aromatic groups having 5 to 14 carbon atoms and the term “substituted arylene” refers to arylene groups further bearing one or more substituents as defined herein.

In embodiments, provided herein are methods for treating or inhibiting bacterial, fungal, or fouling contamination in water, on wetted surfaces, and consumer and industrial surfaces, the method comprising administrating a composition in an effective amount comprising one or more of an organophosphorous compound, organosulfurous compound, and an antimicrobial, and sonication.

The compositions described herein include one or more organophosphorous and/or organosulfurous compounds, one or more derivatives thereof, one or more salts, acids, bases, hydrates, or solvates thereof, or one or more solvates of the salts thereof. In embodiments, the one or more organophosphorous and/or organosulfurous compounds are described below. The compositions described herein further include one or more antimicrobial agents, surfactants, antifoaming agents, preservatives, agents providing scent, solvents, or a combination of one or more thereof.

In embodiments, the compounds described herein are represented by Formula I, or a salt, acid, base, hydrate, or solvate thereof:

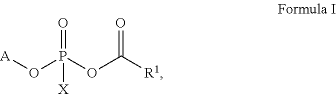

wherein A is C₁₋₁₀ hydrocarbyl or C₁₋₁₀ hydrocarbyl substituted with R¹; X is NHR, NHOR, NHCOR, NHOCOR, or OR; and R is H or C₁₋₁₀ hydrocarbyl;
R¹ is hydrogen, halogen, cyano, OH, C₁₋₆ hydrocarbyl, C₁₋₆ alkoxy, SOR², SO₂R², SO₂NR³R⁴COR², CO₂R², CONR³R⁴, NR³R⁴, NR³COR⁴, NR³SO₂R⁴, NR³CO₂R⁴, NR³CONR⁴, OCOR², or phosphonic acid, wherein each of C₁₋₆ hydrocarbyl, C₁₋₆ alkoxy, SOR², SO₂R², SO₂NR³R⁴, COR², CO₂R², CONR³R⁴, NR³R⁴, NR³COR⁴, NR³SO₂R⁴, NR³CO₂R⁴, NR³CONR⁴, or OCOR², can be optionally substituted with halo, amino, hydroxyl, C₁₋₆ hydrocarbyl, C₁₋₆alkoxy, cyano, or phosphonic acid; and
R², R³, and R⁴ are independently selected from hydrogen or C₁₋₆ hydrocarbyl, wherein each of the C₁₋₆ hydrocarbyls can be optionally substituted with halo, amino, hydroxyl, C₁₋₆ alkoxy, cyano, or phosphonic acid.

In embodiments, X is NHR, NH₂, OH, or OR.

With respect to any relevant structural representation, such as Formula I, in embodiments, R is H or C₁₋₁₀ hydrocarbyl, including C₁₋₁₀alkyl (e.g. methyl; C₂ alkyl, such as ethyl; C₃ alkyl, such as propyl, isopropyl, cyclopropyl, etc.; C₄ alkyl, such as linear, branched or cyclic, butyl, etc.; C₅ alkyl, C₆ alkyl, C₇ alkyl, C₈ alkyl, C₉ alkyl, or C₁₀alkyl), C₁₋₆ alkyl, C₁₋₃ alkyl, C₁₋₁₀ alkenyl (e.g. C₂ alkenyl, such as vinyl; C₃ alkenyl, such as —CH₂—CH═CH₂; C₄ alkenyl, such as linear, branched or cyclic, butenyl, etc.; C₅ alkenyl, C₆ alkenyl, C₇ alkenyl, C₈ alkenyl, C₉ alkenyl, or C₁₀ alkenyl), C₂₋₆ alkenyl, C₂₋₄ alkenyl; optionally substituted aryl, such as phenyl; or hydrocarbyl substituted phenyl, naphthyl, etc. In embodiments, R is H, C₁₋₆ alkyl, C₁₋₃ alkyl, or CH₃.

With respect to any relevant structural representation, such as Formula I, in embodiments, A is C₁₋₁₀ hydrocarbyl, including C₁₋₁₀ alkyl (e.g. methyl; C₂ alkyl, such as ethyl; C₃ alkyl, such as propyl, isopropyl, cyclopropyl, etc.; C₄ alkyl, such as linear, branched or cyclic, butyl, etc.; C₅ alkyl, C₆ alkyl, C₇ alkyl, C₈ alkyl, C₉ alkyl, or C₁₀alkyl), C₁₋₆alkyl, C₁₋₃ alkyl, C₁₋₁₀ alkenyl (e.g. C₂ alkenyl, such as vinyl; C₃ alkenyl, such as —CH₂—CH═CH₂; C₄ alkenyl, such as linear, branched or cyclic, butenyl, etc.; C₅ alkenyl (such as isopentenyl), C₆ alkenyl, C₇ alkenyl, C₈ alkenyl, C₉ alkenyl, or C₁₀ alkenyl), C₂₋₆ alkenyl, C₂₋₄ alkenyl; optionally substituted aryl, such as phenyl; or hydrocarbyl substituted phenyl, naphthyl, etc.

With respect to any relevant structural representation, such as Formula I, in embodiments, A is C₃₋₆ alkyl. In embodiments, A is C₃ alkyl, such as n-propyl, isopropyl, or cyclopropyl. In embodiments, A is C₄ alkyl, such as n-butyl, t-butyl, or cyclobutyl. In embodiments, A is C₅ alky, such as n-pentyl, isopentyl, cyclopentyl, etc. In embodiments, A is C₆, alkyl, such as n-hexyl, cyclohexyl, etc. In embodiments, A is C₃₋₅ alkenyl, such as propenyl, butenyl, isopentenyl, pentenyl, etc. In embodiments, A is C₅ alkenyl, isopentenyl, or prenyl.

With respect to any relevant structural representation, such as Formula I, in embodiments, A is —(CH₂)₁₋₂-Cy, wherein Cy is optionally substituted cycloalkyl (such as cyclopropyl, cyclobutyl, cyclopentyl, cyclohexyl) or optionally substituted phenyl. In embodiments, A is

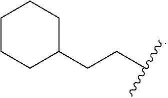 [SMILES: *CCC1CCCCC1]

In embodiments, A is

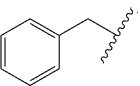 [SMILES: *Cc1ccccc1]

Examples of compounds of Formula I wherein X is NH₂ include compounds shown in Tables 1 and 2.

TABLE 1

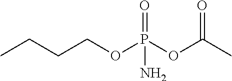

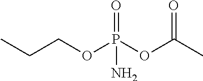

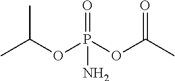

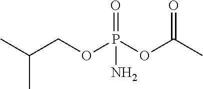

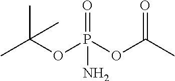

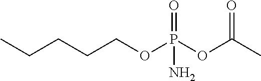

TABLE 2

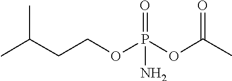

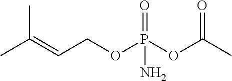

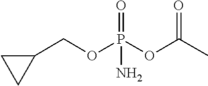

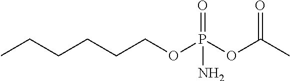

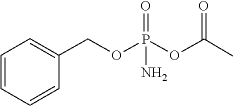

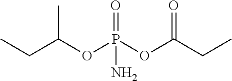

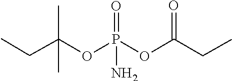

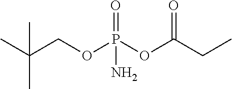

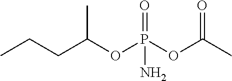

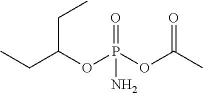

Examples of compounds of Formula I wherein X is OH include compounds shown in Table 3.

TABLE 3

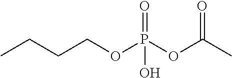

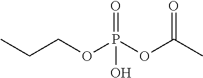

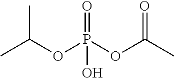

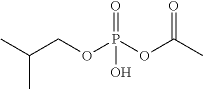

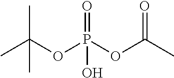

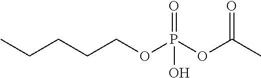

Examples of compounds of Formula I wherein X is OR¹, and R¹ is hydrocarbyl include compounds shown in Table 4.

TABLE 4

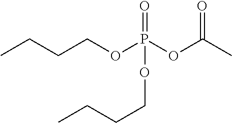 [SMILES: CCCCOP(=O)(OCCCC)OC(C)=O]

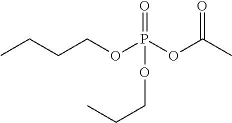

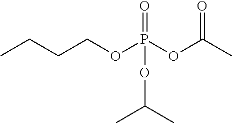

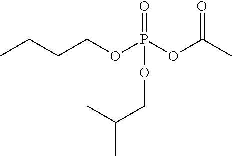 [SMILES: CCCCOP(=O)(OCC(C)C)OC(C)=O]

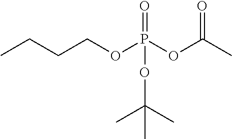 [SMILES: CCCCOP(=O)(OC(C)=O)OC(C)(C)C]

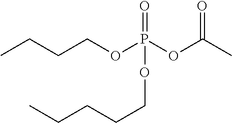 [SMILES: CCCCCOP(=O)(OCCCC)OC(C)=O]

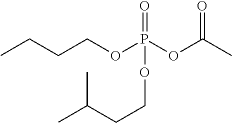 [SMILES: CCCCOP(=O)(OCCC(C)C)OC(C)=O]

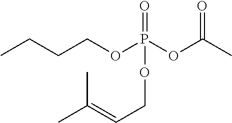 [SMILES: CCCCOP(=O)(OCC=C(C)C)OC(C)=O]

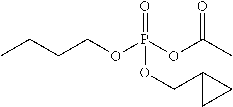 [SMILES: CCCCOP(=O)(OCC1CC1)OC(C)=O]

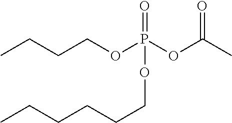 [SMILES: CCCCCCOP(=O)(OCCCC)OC(C)=O]

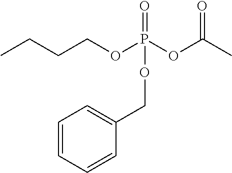 [SMILES: CCCCOP(=O)(OCc1ccccc1)OC(C)=O]

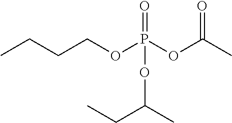 [SMILES: CCCCOP(=O)(OC(C)=O)OC(C)CC]

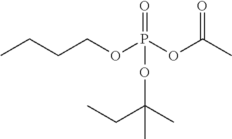 [SMILES: CCCCOP(=O)(OC(C)=O)OC(C)(C)CC]

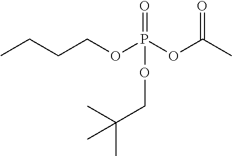 [SMILES: CCCCOP(=O)(OCC(C)(C)C)OC(C)=O]

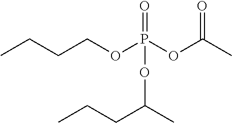 [SMILES: CCCCOP(=O)(OC(C)=O)OC(C)CCC]

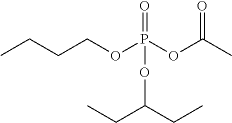 [SMILES: CCCCOP(=O)(OC(C)=O)OC(CC)CC]

In embodiments, the compounds described herein are represented by Formula II, or a salt, acid, base, hydrate, or solvate thereof:

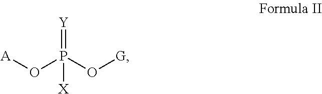

wherein A is R; Y is O or S; X is NH₂, OH, or OR; and G is R, wherein R is C₁₋₁₆ hydrocarbyl.

An example of a compound of Formula II includes a compound of Formula II wherein X is NH₂; A is (CH₂)₃CH₃; Y is O; G is OR; and R is C₁₋₁₀ hydrocarbyl.

Another example of a compound of Formula II includes a compound of Formula II wherein X is NH₂; A is (CH₂)₃CH₃; Y is O; G is OR; and R is C₅H₉, which is represented by the following structure:

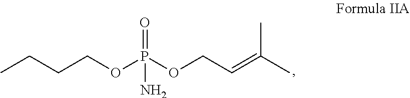

Examples of compounds of Formula II wherein X is NH₂, A is (CH₂)₃CH₃, Y is O, and G is OR, and R is C₁₋₁₀ hydrocarbyl include the compounds shown in Table 5.

TABLE 5

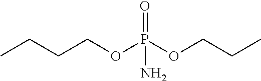

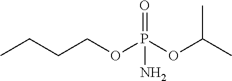

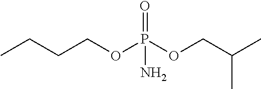

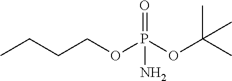

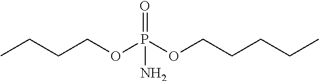

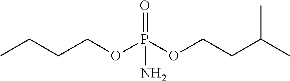

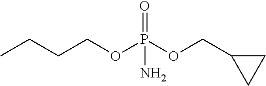

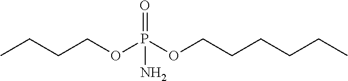

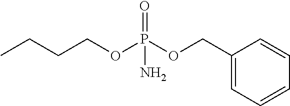 [SMILES: CCCCOP(N)(=O)OCc1ccccc1]

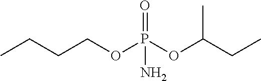

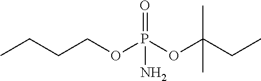

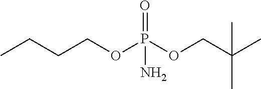

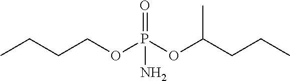

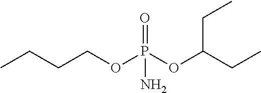

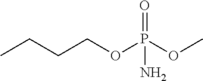

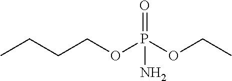

In embodiments, compounds of Formula II also include compounds of Formula II, wherein X is OH; A is R; Y is O; G is OR; and R is C₁₋₁₀ hydrocarbyl, which is represented by the following structure:

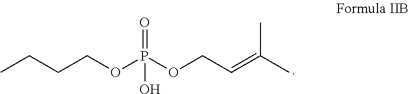

In embodiments, the compound of Formula II, wherein X is NH₂, Y is S, A is (CH₂)₃CH₃, and G is CH (CH₃)₂, has the following structure:

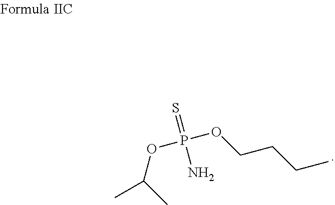

In embodiments, the compound described herein is represented by Formula III or a salt, acid, base, hydrate, or solvate thereof:

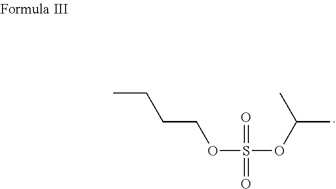

In embodiments, the compound described herein is represented by Formula IV, or a salt, acid, base, hydrate, or solvate thereof:

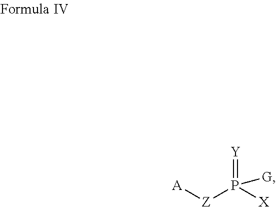

wherein A is H, C₁₋₁₆ hydrocarbyl or C₁₋₁₆ hydrocarbyl substituted with R¹; Z is O or a bond; Y is O; G is OH, H, C₁₋₆—COO-alkyl, O—C₁₋₁₆ alkyl, C₁₋₁₆ hydrocarbyl, R¹ substituted C₁₋₁₆ hydrocarbyl, CH₂NHCH₂COOH, or O-aryl; X is H, CN, —NHR, —NHOR, —NHOCOR, C₁₋₁₀ hydrocarbyl, R¹ substituted C₁₋₁₀ hydrocarbyl, or OR; and R is H, C₁₋₁₀ hydrocarbyl, or R¹ substituted C₁₋₁₀ hydrocarbyl;
R¹ is halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, or phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³, and R⁴ are independently selected from hydrogen, C₁₋₆ hydrocarbyl, in which each of the C₁₋₆ hydrocarbyls can be optionally substituted with halo, amino, hydroxyl, C₁₋₆ alkoxy, cyano, or phosphonic acid.

In embodiments, the compound described herein is represented by Formula V, or a salt, acid, base, hydrate, or solvate thereof:

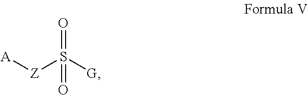

wherein A is H, C₁₋₂₀ hydrocarbyl, alkylaryl, or C₁₋₂₀ hydrocarbyl substituted with R¹; Z is O or a bond; G is OH, H, C₁₋₆—COO-alkyl, O—C₁₋₆ alkyl, C₁₋₁₆ hydrocarbyl,
R¹ substituted C₁₋₁₆ hydrocarbyl, CH₂NHCH₂COOH, or O-aryl;
R¹ is halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, or phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³, and R⁴ are independently selected from hydrogen, C₁₋₆ hydrocarbyl, in which each of the C₁₋₆ hydrocarbyls can be optionally substituted with halo, amino, hydroxyl, C₁₋₆ alkoxy, cyano, or phosphonic acid.

With respect to any relevant structural representation, such as Formula IV or Formula V, in embodiments, Z is O or a bond. In embodiments, Z is O or Z is a bond.

With respect to any relevant structural representation, such as Formula IV, in embodiments, Y is O.

With respect to any relevant structural representation, such as Formula IV or Formula V, in embodiments, G is OH, O-alkyl (such as OCH₃, OC₂H₅, OC₃H₇, OC₄H₉, OC₅H₁₁, OC₆H₁₃, etc.), C₁₋₆—COO-alkyl, C₁₋₁₆ hydrocarbyl, R¹ substituted C₁₋₁₆ hydrocarbyl, or O-aryl. In embodiments, G is OCH₃, OC₂H₅, OC₄H₉. CH₂COOCH₃, OCH₂CF₃, C₂H₄CHNH₂COOH, O-phenyl, CH₂NHCH₂COOH, or ONa.

With respect to any relevant structural representation, such as Formula IV, in embodiments, X is H, CN, NHR, NHOR, NHOCOR, C₁₋₁₀ hydrocarbyl, R¹ substituted C₁₋₁₀ hydrocarbyl, or OR; and R is H, C₁₋₁₀ hydrocarbyl, or R¹ substituted C₁₋₁₀ hydrocarbyl. In embodiments, X is H, OR, OH, OCH₃, OC₂H₅, NHR, NH₂, OCH₂CF₃, or CN.

With respect to any relevant structural representation, such as Formula IV, in embodiments, R is H or C₁₋₁₀ hydrocarbyl, including C₁₋₁₀alkyl (e.g. methyl; C₂ alkyl, such as ethyl; C₃ alkyl, such as propyl, isopropyl, cyclopropyl, etc.; C₄ alkyl, such as linear, branched or cyclic, butyl, etc.; C₅ alkyl, C₆ alkyl, C₇ alkyl, C₈ alkyl, C₉ alkyl, or C₁₀alkyl), C₁₋₆alkyl, C₁₋₃ alkyl, CMO alkenyl (e.g. C₂ alkenyl, such as vinyl; C₃ alkenyl, such as CH₂—CH═CH₂, C₄ alkenyl, such as linear, branched or cyclic, butenyl, etc.; C₅ alkenyl, C₆ alkenyl, C₇ alkenyl, C₈ alkenyl, C₉ alkenyl, or C₁₀ alkenyl), C₂₋₆ alkenyl, C₂₋₄ alkenyl, or aryl or optionally substituted aryl, such as phenyl or hydrocarbyl substituted phenyl, naphthyl, etc. In embodiments, R is H, C₁₋₆ alkyl, C₁₋₃ alkyl, CH₃, C₂H₅, or CH₂CF₃.

With respect to any relevant structural representation, such as Formula IV or Formula V, in embodiments, A is H, C₁₋₂₀ hydrocarbyl, including C₁₋₁₂ alkyl (e.g. methyl; C₂ alkyl, such as ethyl; C₃ alkyl, such as propyl, isopropyl, cyclopropyl, etc.; C₄ alkyl, such as linear, branched or cyclic, butyl, etc.; C₅ alkyl, C₆ alkyl, C₇ alkyl, C₈ alkyl, C₉ alkyl, C₁₀alkyl, C₁₁ alkyl or C₁₂ alkyl), C₁₋₆alkyl, C₁₋₃ alkyl, C₁₋₁₀ alkenyl (e.g. C₂ alkenyl, such as vinyl; C₃ alkenyl, such as —CH₂—CH═CH₂, C₄ alkenyl, such as linear, branched or cyclic, butenyl, etc.; C₅ alkenyl (such as isopentenyl), C₆ alkenyl, C₇ alkenyl, C₈ alkenyl, C₉ alkenyl, or C₁₀ alkenyl), C₂₋₆ alkenyl, C₂₋₄ alkenyl, aryl; such as phenyl or naphthyl, alkylaryl; or optionally R¹ substituted C₁₋₂₀ hydrocarbyl.
R¹ is selected from halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, and phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆alkoxy, cyano, or phosphonic acid; and
R², R³, and R⁴ are independently selected from hydrogen, C₁₋₆ hydrocarbyl, in which each of the C₁₋₆ hydrocarbyls can be optionally substituted with halo, amino, hydroxyl, C₁₋₆alkoxy, cyano, or phosphonic acid.

With respect to any relevant structural representation, such as Formula IV or Formula V, in embodiments, A is H. In embodiments, A is C₁₋₆alkyl; ethyl; C₃ alkyl, such as n-propyl, isopropyl, or cyclopropyl; C₄ alkyl, such as n-butyl, t-butyl, or cyclobutyl; C₅ alky, such as n-pentyl, isopentyl, cyclopentyl, etc.; C₆ alkyl, such as n-hexyl, cyclohexyl, etc.; C₃₋₅ alkenyl, such as propenyl, butenyl, isopentenyl, pentenyl, etc.; or alkylaryl.

With respect to any relevant structural representation, such as Formula IV or Formula V, in embodiments, A is —(CH₂)₁₋₂-Cy, wherein Cy is optionally substituted cycloalkyl (such as cyclopropyl, cyclobutyl, cyclopentyl, cyclohexyl) or optionally substituted phenyl. In embodiments, A is

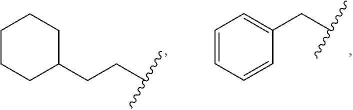 [SMILES: *CCC1CCCCC1 ; *Cc1ccccc1]

R¹ substituted alkyl, CF₃, C₂H₄OH, 1-amino-1-phenyl methyl, or 1-amino-2-phenyl-ethyl.

In embodiments of Formula IV, Y is O; Z is O; A is C₄H₉; G is OC₄H₉; and X is H, OH, OCH₃, or NH₂.

In embodiments of Formula IV, Y is O; Z is O; A is CH₂CF₃; G is CH₂OOCH₃; and X is OCH₂CF₃. In embodiments, Y is O; Z is O; A is CH₂CF₃; G is OCH₂CF₃; and X is H. embodiments, Y is O; Z is O; A is C₂H₅; G is OC₂H₅; and X is CF₂Br. In embodiments, Y is O; Z is O; A is C₂H₅; G is OC₂H₅; and X is ON.

In embodiments of Formula IV, Y is O; Z is a bond; A is C₂H₄OH; G is OCH₃; and X is OCH₃.

Examples of compounds of Formula IV include the compounds shown in Table 6.

TABLE 6

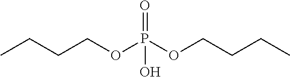

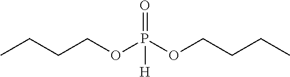

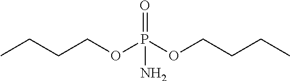

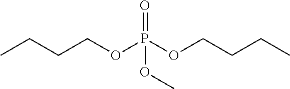

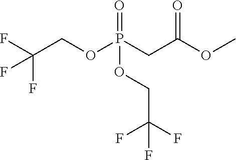 [SMILES: COC(=O)CP(=O)(OCC(F)(F)F)OCC(F)(F)F]

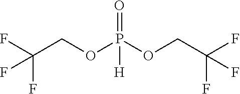 [SMILES: O=[PH](OCC(F)(F)F)OCC(F)(F)F]

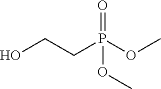

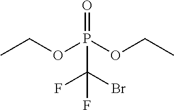

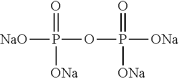

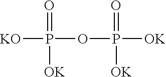

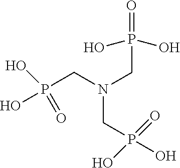 [SMILES: O=P(O)(O)CN(CP(=O)(O)O)CP(=O)(O)O]

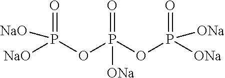

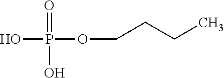

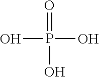

Examples of compounds of Formula IV also include compounds shown in Table 7.

TABLE 7

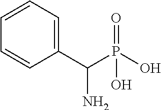 [SMILES: NC(c1ccccc1)P(=O)(O)O]

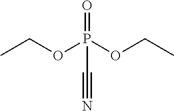

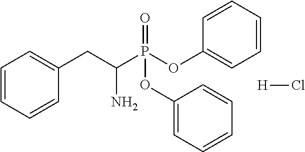

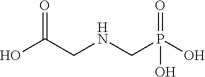

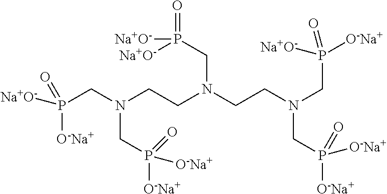

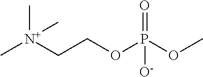

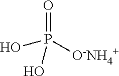

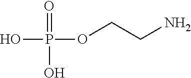

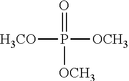

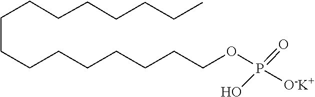

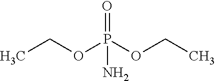

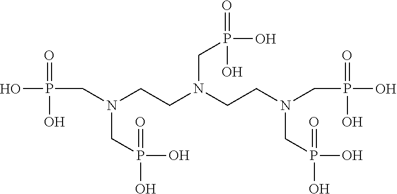 [SMILES: O=P(O)(O)CN(CCN(CP(=O)(O)O)CP(=O)(O)O)CCN(CP(=O)(O)O)CP(=O)(O)O]

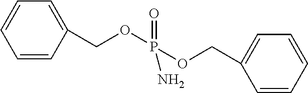 [SMILES: NP(=O)(OCc1ccccc1)OCc1ccccc1]

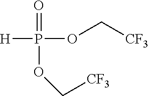 [SMILES: O=[PH](OCC(F)(F)F)OCC(F)(F)F]

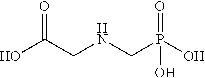

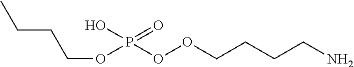

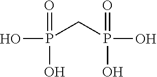

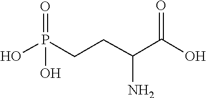 [SMILES: NC(CCP(=O)(O)O)C(=O)O]

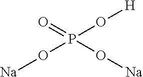

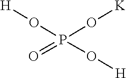

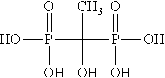

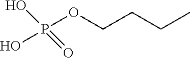

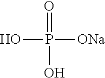

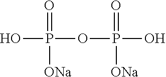

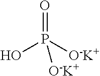

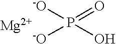

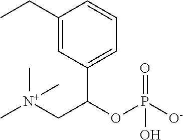 [SMILES: CCc1cccc(C(C[N+](C)(C)C)OP(=O)([O-])O)c1]

Examples of compounds of Formula IV also include the compounds shown in Table 8.

TABLE 8

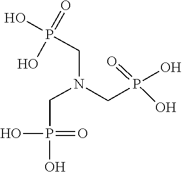 [SMILES: O=P(O)(O)CN(CP(=O)(O)O)CP(=O)(O)O]

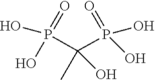

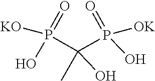

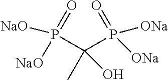

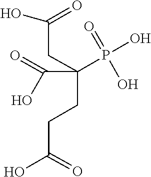 [SMILES: O=C(O)CCC(CC(=O)O)(C(=O)O)P(=O)(O)O]

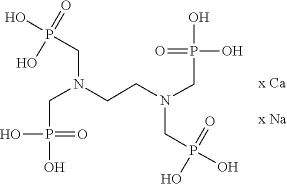 [SMILES: O=P(O)(O)CN(CCN(CP(=O)(O)O)CP(=O)(O)O)CP(=O)(O)O]

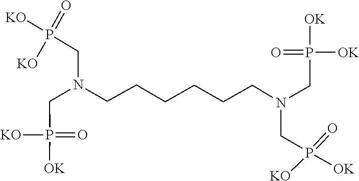

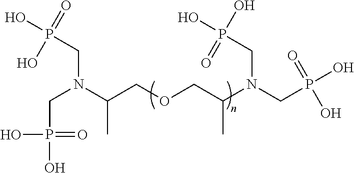

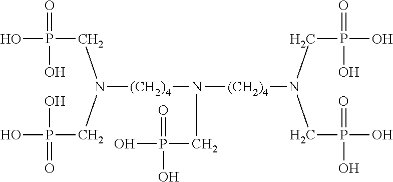

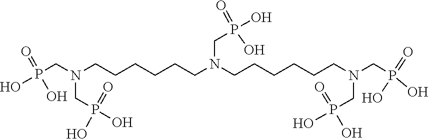 [SMILES: O=P(O)(O)CN(CCCCCCN(CP(=O)(O)O)CP(=O)(O)O)CCCCCCN(CP(=O)(O)O)CP(=O)(O)O]

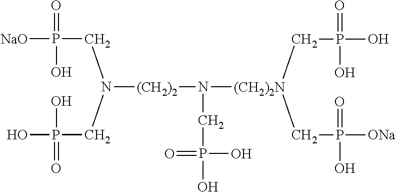

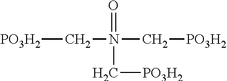

Examples of compounds of Formula IV also include compounds shown in Table 9.

TABLE 9

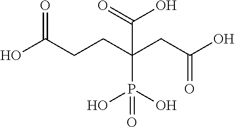 [SMILES: O=C(O)CCC(CC(=O)O)(C(=O)O)P(=O)(O)O]

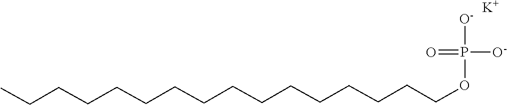 [SMILES: [K+] ; CCCCCCCCCCCCCCCCOP(=O)([O-])[O-]]

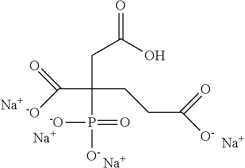

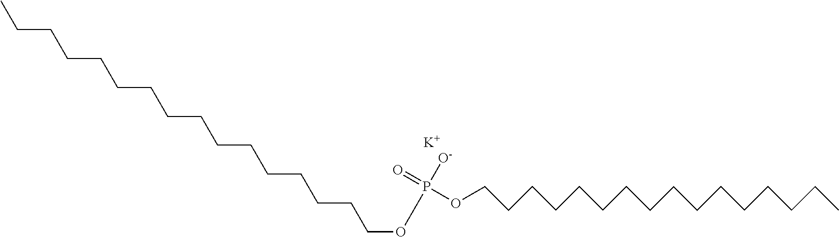 [SMILES: CCCCCCCCCCCCCCCCOP(=O)([O-])OCCCCCCCCCCCCCCCC ; [K+]]

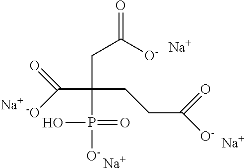

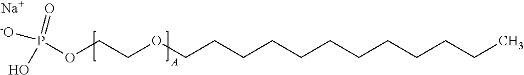

OPO₃⁻²
K⁺ K⁺

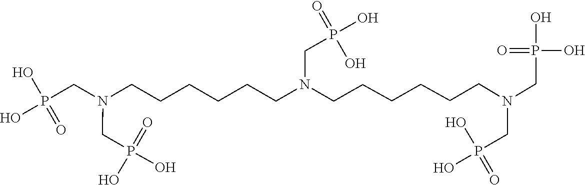 [SMILES: O=P(O)(O)CN(CCCCCCN(CP(=O)(O)O)CP(=O)(O)O)CCCCCCN(CP(=O)(O)O)CP(=O)(O)O]

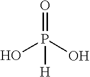

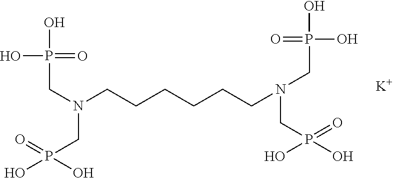 [SMILES: O=P(O)(O)CN(CCCCCCN(CP(=O)(O)O)CP(=O)(O)O)CP(=O)(O)O ; [K+]]

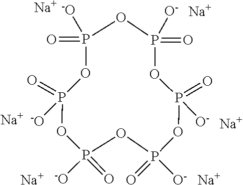

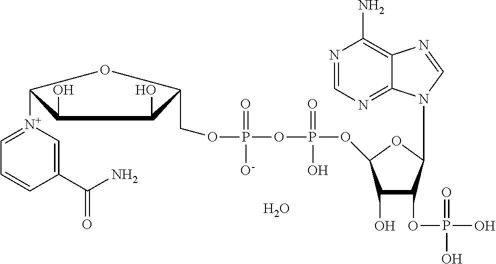

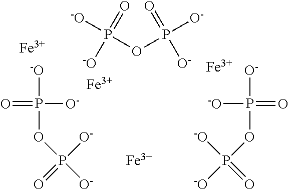

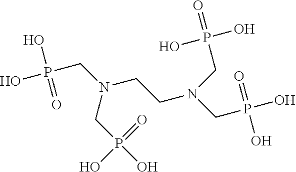 [SMILES: O=P(O)(O)CN(CCN(CP(=O)(O)O)CP(=O)(O)O)CP(=O)(O)O]

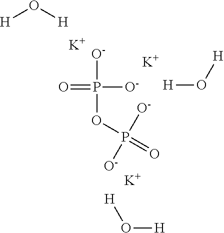

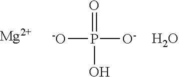

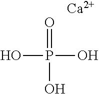

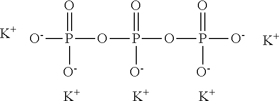 [SMILES: [K+] ; O=P([O-])([O-])OP(=O)([O-])OP(=O)([O-])[O-] ; [K+] ; [K+] ; [K+] ; [K+]]

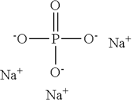

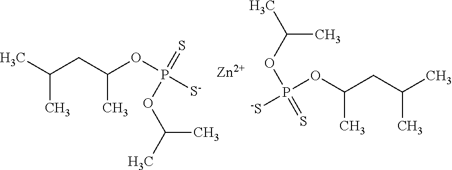

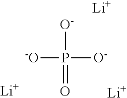

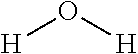

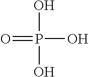

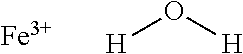

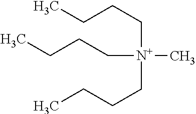

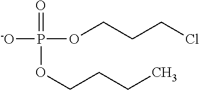

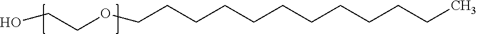

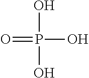

Examples of compounds of Formula V include compounds shown in Table 10.

TABLE 10

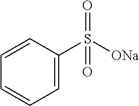

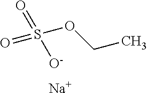

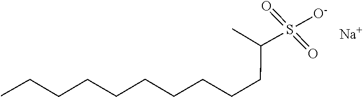 [SMILES: CCCCCCCCCCC(C)S(=O)(=O)[O-] ; [Na+]]

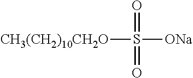

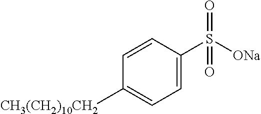

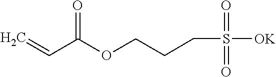

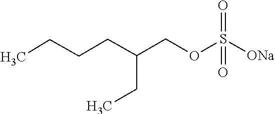

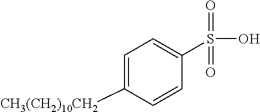

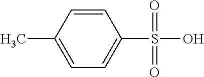

Examples of compounds of Formula V also include compounds shown in Table 11.

TABLE 11

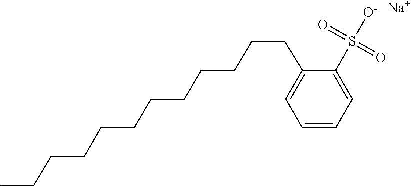 [SMILES: [Na+] ; CCCCCCCCCCCCc1ccccc1S(=O)(=O)[O-]]

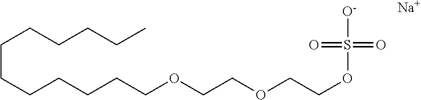 [SMILES: [Na+] ; CCCCCCCCCCCCOCCOCCOS(=O)(=O)[O-]]

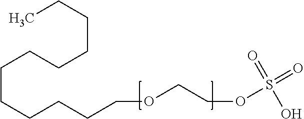

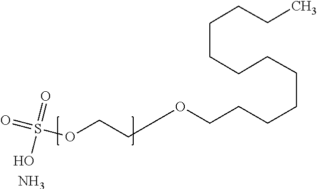

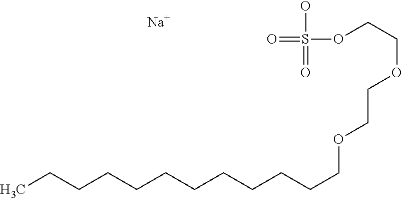 [SMILES: CCCCCCCCCCCCOCCOCCOS(=O)(=O)O ; [Na+]]

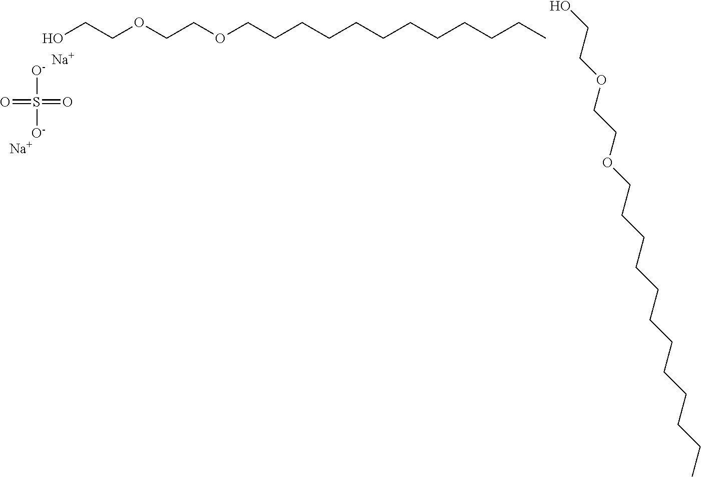

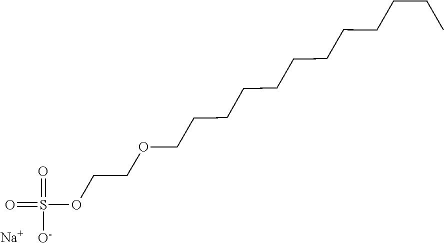 [SMILES: [Na+] ; CCCCCCCCCCCCOCCOS(=O)(=O)[O-]]

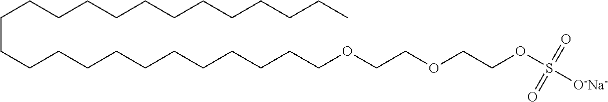

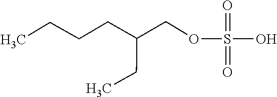

Examples of compounds of Formula V also include compounds shown in Table 12.

TABLE 12

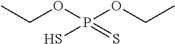

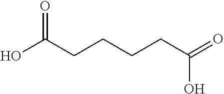

In embodiments, the compounds included in the compositions described herein comprise the organophosphorous and/or organosulfurous compounds, derivatives thereof, salts thereof (including salts of the derivatives), acids thereof, bases thereof, hydrates thereof, and solvates thereof (including acids, bases, hydrates, and solvates of the compounds, derivatives and salts). In embodiments, the compositions described herein include a combination of the organophosphorous and/or organosulfurous compounds, derivatives, salts, acids, bases, hydrates, or solvates described herein. Suitable salts of the compounds disclosed herein can be prepared from an inorganic acid or an organic acid. Examples of such inorganic acids include hydrochloric, hydrobromic, hydroiodic, nitric, carbonic, sulfuric, and phosphoric acids. Appropriate organic acids can be selected from aliphatic, cycloaliphatic, aromatic, arylaliphatic, heterocyclic, carboxylic, sulfonic classes of organic acids, and any appropriate organic acids.

Suitable salts of the compounds disclosed herein can be prepared from a metallic salt. Metallic salts can be prepared from aluminum, calcium, lithium, magnesium, potassium, sodium, and zinc. Organic salts can be prepared from N,N′-dibenzylethylene-diamine, chloroprocaine, choline, diethanolamine, ethylenediamine, N-methylglucamine, lysine, arginine, procaine, and any appropriate organic bases.

The term “derivative” in chemistry refers to a compound that is obtained from a similar compound or a precursor compound by a chemical reaction.

In embodiments, the compounds described herein are obtained from natural components, extracts, supernatant, or conditioned media, including but not limited to butyl phosphoramidate, other organic acids, and H₂O₂ produced by lactic acid producing bacteria, and the marine bacteria Aerococcus viridans (U.S. Pat. No. 10,188,113). As an example, the compounds are obtained from conditioned media or supernatant in which microorganisms are cultured or grown.

In embodiments, the compounds are sodium dodecylbenzenesulfonate (SDBS), sodium dodecyl sulfate (SDS), 4-Dodecylbenzenesulfonic acid (DBSA), butyl phosphoramidate (BPA), (4-aminophenetyl) dimethylphosphine oxide (APDMPO), dibutyl phosphate (DBP), or dibutyl phosphite (DBPT).

In embodiments, the one or more compounds are present in the composition at a concentration of between 0.01 μg/ml to 5000 μg/ml.

In embodiments, the composition described herein remove contaminants. Examples of contaminants include microorganisms (such as algae, bacteria, fungi, and viruses), salt, soil, dirt, suspended solids (such as sand), hydrocarbons (such as oil and fuel), biofilms (such as those formed by bacteria, fungi, algae, extracellular polymeric substances (EPS) or a combination thereof), metals (such as zinc, lead, manganese, iron, and barium), scale deposits (such calcium sulfate, calcium sulfate, and barium sulfate), toxins (such as arsenic and radium), chemicals such as chemical additives injected into the well to facilitate extraction (polymers, carbon dioxide), and a combination thereof. In embodiments, the contaminants can be in the water, on the surface of water, any wet surface, or on industrial or household surfaces, including apparatuses (such as medical devices), counters, and other hard and soft surfaces. The contaminants can be in produced water generated from extraction of extraction of oil and natural gas or used as a medium for heat extraction. In embodiments, the contaminants can be a clump on a surface or floating on the surface of water, such as produced water. The clump can comprise a combination of the exemplary contaminants described herein.

U.S. Pat. No. 10,188,113 and International Applications PCT/US2017/020016 and PCT/US2017/039783, disclose compositions for use in the methods described herein containing organophosphorous and/or organosulfurous compounds which have bacteriostatic, bactericidal, and antibiofilm properties and are useful to treat contamination.

In embodiments, the contaminant is a single or multi-bacterial and/or fungal and/or algal and/or yeast and/or viral contamination.

In embodiments, the contamination includes one or more bacteria, including waterborne bacteria. In embodiments the bacteria include but are not limited to, Campylobacter jejuni, Escherichia coli, Giardia lambia, Hepatitis A, Legionaella pneumophila, Salmonella enterica, and others, as well as Staphylococcus aureus, Staphylococcus epidermidis, Acinetobacter baumannii, Pseudomonas aeruginosa, Enterobacteriaceae, Salmonella bongori, Enterococcus faecium, Helicobacter pylori, Campylobacter spp., Neisseria gonorrhoeae, Streptococcus pneumoniae, Streptococcus mutans, Streptococcus gordonii, Streptococcus pyogenes, Haemophilus influenzae, Shigella spp., Klebsiella pneumoniae, Clostridium difficile, Bacillus anthracis, Yersinia pestis, Francisella tularensis, Burkholderia mallei, Burkholderia pseudomallei, Corynebacterium spp., Micrococcus luteus, Micrococcus lylae, Micrococcus roseus, Cutibaceterium acnes, Vibrio vulnificus, Vibrio cholerae, Vibrio parahaemolyticus, Propionibacterium acnes, Neisseria gonorrhoeae, Burkholderia cepacia, Burkholderia mallei, Burkholderia pseudomallei, Ralstonia pickettii, Cuprividus metalliduran, and/or biofilm-forming bacteria found on aquatic surfaces, including Cobetia marina and others.

In embodiments, the eukaryotic fouling contaminations are caused by algae and microalgae, including Euglenophyta, Chrysophyta, Pyrrophyta, Chlorophyta, Rhodophyta, Paeophyta, and/or Xanthophyta, plants, including sea grasses; and animals, including tunicates, mussels, oysters, clams, barnacles, cnidarians, sponges, and larvae. In embodiments, the fungal contamination is caused by fungi, including Zygomycota, Ascomycota, Basidiomycota, Deuteromycota, and others, and/or other eukaryotic foulers.

The term “effective amount” refers to an amount, concentration, or dosage sufficient to produce a desired result. The effective amount may vary depending on the one or more organophosphorous compounds, organosulfurous compounds, and antibiotics that are being used, and may also depend on a variety of factors and conditions related to the contamination being treated and the severity of the contamination. For example, if the composition is to be administered, factors to be considered include the type of organisms, size of the system, temperature, pH, etc. The determination of an effective amount is within the ability of those skilled in the art. In embodiments, the effective amount of organophosphorous compound and/or organosulfurous compound is administered at a concentration of 0.00001% to 5.0%. In embodiments, the organophosphorous compound and/or organosulfurous compound is administered at a concentration of 1.0% to 2.0%, 2.0% to 3.0%, 4.0 to 5.0%, 0.1% to 1%, 0.0005% to 0.5%, 0.0001% to 0.1%, 0.005% to 0.05%, 0.001% to 0.01%, 0.02% to 0.9%, 0.03% to 0.08%, 0.04% to 0.07%, or 0.05% to 0.06%.

In embodiments, the one or more compounds described herein are antibiofilm agents. In embodiments, an effective amount of the antimicrobial agent is administered at a concentration of 0.000001% to 0.05%. In embodiments, the biocide is administered at a concentration of 0.00001% to 0.0001%, 0.0005% to 0.005%, 0.001% to 0.01%, 0.01% to 0.04%, or 0.02% to 0.03%.

The use of one or more compounds in combination to treat contamination, provides significant benefits to treating a variety of organisms that contaminate fresh, salt, and potable water systems. In embodiments, the organophosphorous and/or organosulfurous compounds are used in combination with an antimicrobial and/or sonication.

In embodiments, the antimicrobial agent may be oxidizing (halogenated, non-halogenated, and acid) biocides, metals (ionic or salts), and/or non-oxidizing biocides, ozonated water, acids, naturally-occurring biocides such as chitosan, and/or plant derived compound.

In embodiments, the biocides include, chlorine (free chlorine, hypochlorous acid, hypochlorite salts), chlorine dioxide, sodium chloride, bromine, iodine, hydrogen peroxide, chlorhexidine, bismuth thiols (e.g, bismuth ethanedithiol), potassium permanganate, paracetic acid, propionic salts, parabens, 2-(Decylthio)ethanamine (DTEA), glutaraldehyde, ortho-phthalaldehyde, tetrakish(hydroxymethyl)phosphonium sulfate (THPS), tributyltetradecylphosphonium chloride (TTPC), 2-Bromo-4-hydroxyacetopne (BHAP), 2-Bromo-2-nitropropane-1,3-diol (Bronopol), sodium dimethyldithiocarbamate (DIBAM), disodium ethylene bisdithiocarbamate (NIBAM), potassium n-hydroxymethyl-n-methyldithiocarbamate, 2,2 Dihydroxy-5,5-dichlorodiphenyl monosulfide (Chlorothioether), 2-2-Dibromo-3-nitrilopropionamide (DBNPA), methylene bis(thiocyanate) (MBT), polyquats (e.g., poly[oxyethylene (dimethyliminio)ethylene,dichloride]), quaternary ammonium compound (Quats) (e.g., alkyldimethylbenzylammonium chloride, ADBACs), sulfone (e.g., Bis(trichloromethyl) sulfone), bis(tributyltin) oxide (TBTO), 2-(tert-butylamino)-4-chloro-6-(ethylamino)-s-triazine (TBZ), tetrachloro-2,4,6-cyano-3-benzonitrile (TCCBN), 2(thiocyanomethylthio)benzothiazole (TCMTB), tetrahydro-3,5,dimethyl-2H-1,3,5-thiadiazine-2-thione, isothiazolines including 5-chloro-2-methyl-4-isothiazolin-3-one and 2-methyl-4-isothiazolin-3-one, and 1,2-benzisothiazolin-3-one (BIT), guanides, including, guanidine and biguanides (e.g., dodecylguanidine hydrochloride and acetate, polyhexamethylene biguanide hydrochloride, and/or tetradecylguanidine. In embodiments, the concentration of biocide is a concentration of between 0.01% to 5%, 0.01% to 0.1%, 0.1% to 1.0%, 1.0% to 2.0%, 2.0% to 3.0%, 3.0% to 4.0%, or 4.0% to 5.0%. In embodiments, the concentration of chlorine is a concentration between 0.1 ppm to 50 ppm, 0.1 ppm to 1.0 ppm, 1.0 ppm to 5 ppm, 5 ppm to 10 ppm, 10 ppm to 20 ppm, 20 ppm to 30 ppm, 30 ppm to 40 ppm, or 40 ppm to 50 ppm.

In embodiments, the metal is silver, gold, copper, zinc, or their derivatives. In embodiments, the concentration of metal is administered at a concentration of 0.01% to 0.1%, 0.1% to 1.0%, 1.0% to 2.0%, 2.0% to 3.0%, 3.0% to 4.0%, or 4.0% to 5.0%. In embodiments, the silver compound is silver ions, silver particles, silver nanoparticles, metallic silver, colloidal silver, silver sulfate, and/or silver chloride. In embodiments, the concentration of the silver is a concentration of between 0.01 ppm to 30 ppm, 0.01 ppm to 0.1 ppm, 0.1 ppm to 50 ppm, 0.1 ppm to 1.0 ppm, 1.0 ppm to 5 ppm, 5 ppm to 10 ppm, 10 ppm to 20 ppm, 20 ppm to 30 ppm. In embodiments, the zinc compound includes, zinc acetate, zinc octoate, zinc pyrithione, zinc sulfate, and/or zinc oxide. In embodiments, the concentration of zinc is a concentration of between 0.01 to 5%. In embodiments, the zinc is administered at a concentration of 0.01% to 0.1%, 0.1% to 1.0%, 1.0% to 2.0%, 2.0% to 3.0%, 3.0% to 4.0%, or 4.0% to 5.0%.

In embodiments, the concentration of chitosan is a concentration of between 0.01 to 5%. In embodiments, the chitosan is administered at a concentration of 0.01% to 0.1%, 0.1% to 1.0%, 1.0% to 2.0%, 2.0% to 3.0%, 3.0% to 4.0%, or 4.0% to 5.0%.

In embodiments, the concentration of acid is a concentration of between 0.01% to 5%. In embodiments, the acid is administered at a concentration of 0.01% to 0.1%, 0.1% to 1.0%, 1.0% to 2.0%, 2.0% to 3.0%, 3.0% to 4.0%, or 4.0% to 5.0%.

In embodiments, the plant derived compound includes orange essential oil, lemon essential oil, oregano essential oil, thyme essential oil, cinnamon essential oil, citral, cinnamaldehyde, carvacrol, thymol, citric acid, itaconic acid, aconitic acid, isocitric acid, succinic acid, fumaric acid, malic acid, glyoxylic acid, pyruvic acid, 2-oxoglutaric acid, 2-phosphoenolpyruvic acid, phosphoenolpyruvate carboxylase, glycolic acid, and aloe. In embodiments, the concentration of plant derived compound is a concentration of between 0.01 to 5%, 0.01% to 0.1%, 0.1% to 1.0%, 1.0% to 2.0%, 2.0% to 3.0%, 3.0% to 4.0%, or 4.0% to 5.0%. In embodiments, the acid is maleic acid, clavulanic acid, glucaric acid, formic acid, carboxylic acid, hypochlorous acid, and/or hydrochloric acid. In embodiments, the concentration of acid is a concentration of between 0.001 to 5%, 0.001% to 0.01%, 0.01% to 0.1%, 0.1% to 1.0%, 1.0% to 2.0%, 2.0% to 3.0%, 3.0% to 4.0%, or 4.0% to 5.0%.

In embodiments, the organophosphorous and/or organosulfurous compounds are used in combination with an additional antibiofilm agent. In embodiments, the antibiofilm agent includes but is not limited to an enzyme. In embodiments, the enzyme N-acetyl-glucosaminidase, deacetylase, alginate lyases (mannuronate lyase or guluronate lyase), and DNase.

In embodiments, the organophosphorous or organosulfurous compounds and/or antimicrobials are used with sonication. In embodiments, the compounds are used with a sonicating brush, sonicating bath, and boat ultrasonic cleaner. In embodiments, the compounds are used after a surface is treated with sonication. In embodiments, the ultrasonic frequency is 20 kHz to 40 kHz.

The compositions described herein further include one or more surfactants, one or more antifoaming agents, one or more preservatives, one or more agents providing scent, one or more solvents, or a combination thereof.

In embodiments, the surfactant is an anionic, cationic, non-ionic, amphoteric, or a combination thereof. In embodiments, the surfactant is one that is approved for food contact by the Food and Drug Administration. Examples of one or more surfactant includes but is not limited to Alkyl (C8-C24) benzenesulfonic acid and its ammonium, calcium, magnesium, potassium, sodium, and zinc salts; C10-C18-Alkyl dimethyl amine oxides; α-alkyl(C6-C15)-ω-hydroxypoly(oxyethylene)sulfate, and its ammonium, calcium, magnesium, potassium, sodium, and zinc salts; α-alkyl (C12-C15)-ω-hydroxypoly(oxypropylene) poly (oxyethylene) copolymers, lauryl glucoside, decyl glucoside, coco/soy methyl ester, coco/soy methyl ester sulfonate, cocoalkyl amine oxide, cocamide MIPA, caprylyl/myristyl glucoside, and/or caprylyl/decyl glucoside. In embodiments, the concentration of the surfactant is a concentration of between 0.001% to 30%. In embodiments, the surfactant is administered at a concentration of 0.001% to 0.05%, 0.05% to 0.5%, 0.1% to 1%, 1% to 10%, 10% to 20%, 20% to 30%, 5% to 10%, 2.0% to 3.0%, 4.0% to 5.0%, or 5.0% to 6.0%.

Examples of one or more antifoaming or defoaming agents include but are not limited to, silicones, non-ionic emulsifiers, benzoic acid, SE-15™, octanols, polymers, C12-C18 alcohols, Xiameter™, SAG 5693™, and SAG 471™ In embodiments, the concentration of the antifoam agent is administered at a concentration of between 0.001 wt % to 1 wt %. In embodiments, the antifoaming agent is administered at a concentration of 0.001 wt % to 0.1 wt %, 0.05 wt % to 0.5 wt %, 0.1 wt % to 1.0 wt %, or 0.5 wt % to 1.0 wt %.

Examples of one or more preservative include but is not limited to, potassium sorbate, benzyl alcohol, carprylhydroxamic acid, caprylyl glycol, and dehydroacetic acid. In embodiments, the concentration of the preservative is a concentration of between 0.00001 wt % to 0.5 wt %. In embodiments, the preservative is administered at a concentration of 0.0001 wt % to 0.001 wt %, 0.0005 wt % to 0.005 wt %, 0.01 wt % to 0.1 wt %, or 0.1 wt % to 0.5 wt %.

Examples of one or more agents providing scent include but are not limited to, orange, lemon, lime, elderberry, and lavender. In embodiments, the concentration of the agent providing scent is a concentration of between 0.001 wt % to 5 wt %. In embodiments, the agent providing scent is administered at a concentration of 0.05 wt % to 0.5 wt %, 0.1 wt % to 1.0 wt %, 2.0 wt % to 3.0 wt %, 3.0 wt % to 4.0 wt %, or 4.0 wt % to 5.0 wt %.

Examples of one or more solvent includes but is not limited to, water, alcohol, acetic acid, acetic anhydride, acetone, citric acid, lactic acid, dioxolane, supernatant, cultured media, and growth media. In embodiments, the concentration of the solvent is a concentration of between 1% to 99.999%. In embodiments, the solvent is administered at a concentration of 99.99% to 9.9%. 99.0% to 95.0%, 97.0% to 95.0%, 94.0% to 91.0%, 90.0% to 80.0%, 80.0% to 70.0%, 70.0% to 60.0%, 60.0% to 50.0%, 50.0% to 40.0%, 40.0% to 30.0%, 30.0% to 20.0%, 20.0% to 10.0%, or 10.0% to 1.0%.

Compositions of the present invention may optionally include one or more of the conventional additives known to be useful in water treatments and cleaners including viscosity modification agents, pH adjusters, foaming agents, water softening agents, emulsifiers, additional co-surfactants including anionic, cationic, nonionic, amphoteric, and zwitterionic surface active agents, additional organic solvents for stability purposes, chelating agents, cleaning enzymes, stabilizers, moisturizers, softening agents, antistatic agents, and coloring agents. The total weight of the additional additives may comprise up to 20 wt % of the composition. The optional ingredients are well known to those of ordinary still in the art.

Further provided herein is a method of preventing and/or removing microorganisms on or surface, such as an industrial or household surface, the method comprising contacting a surface with a composition in an effective amount comprising one or more of an organophosphorous compound, organosulfurous compound, and antimicrobial.

In embodiments, the composition is a cleaning agent, dispersant, surfactant; and/or anti-odor agent, agent to disrupt, remove, prevent and/or inhibit biofilm; agent to disrupt, remove, prevent and/or remove fouling; agent to disrupt, remove, prevent, and/or inhibit microbial growth and kill microorganisms, including bacteria, fungi, viruses, and other microorganisms.

In embodiments, the composition is in an automatic or manually operated dispenser. In embodiments, the dispenser dispenses the composition on a surface or in water. In embodiments, the dispenser is for a handrail for a moving walkway or escalator.

The use of compounds described herein has been found to enhance the antibiotic properties of antimicrobials, including but not limited to methylisothiazolinone (MIT), 5-Chloro-2-methyl-4-isothiazolin-3-one (CMIT), and 1,2-benzisothiazolin-3-one (BIT), peracetic acid, glutaraldehyde, tetrakis(hydroxymethyl) phosphonium sulfate, sodium pyrithione (NaPT), decyl glucoside, lactic acid, potassium sorbate, orange essential oil, cinnamaldehyde, citral, carvacrol, pine oil, citric acid, elderberry, and/or acetic acid.

Combination treatment can result in antimicrobial synergy in which two or more antimicrobials at low concentrations work together resulting in a greater potency than if each antimicrobial was used separately.

In embodiments, a combination treatment is provided for the use in a method of treatment or inhibition of contamination, the method comprising administration of a composition to the site. In embodiments, the composition is formulated into a liquid dosage form. In a second embodiment, the composition is administered in a dry dosage form, more specifically a powder, pressed powder, or tablet. In a third embodiment, the composition is administered in a wetted dosage form, more specifically a paste.

In embodiments, a method is provided of treating or preventing contamination in water, on a wetted surface, and on a dry surface by administration of an effective amount of the compositions disclosed herein to water, wetted surfaces, or dry surfaces. The water treated herein includes produced water, wastewater, ground water, surface water, wastewater and ground water systems, and their filtration systems. Wastewater treatment processes remove contaminants from wastewater and convert it into an effluent that can be returned to the water cycle. Groundwater is treated by pumping the water to the surface and treatment of the water with a filtration system to remove contaminants. The water can be produced water from the extraction of oil and natural gas or used as a medium for heat extraction.

The disclosure describes a method of using the organophosphorous and/or organosulfurous compounds in combination with one or more other compounds to treat produced water. Produced water is used by the oil industry and geothermal industry to refer to water that is produced as a byproduct during the extraction of oil and natural gas or used as a medium for heat extraction. Produced water is saline water from underground formations that have been brought to the surface. Produced water contains a mixture of dissolved and particulate inorganic and organic matters, and can also be called “brine”, “saltwater”, or “formation water.” Produced water from oil fields contains oil and suspended solids. Produced water can contain heavy metals and other contaminants including microorganisms, such as bacteria, yeast, fungi, microalgae, and others.

Produced water is considered industrial waste and historically, is disposed of in large evaporation ponds. Evaporation ponds are artificial ponds with large surface areas designed to efficiently evaporate water by sunlight and expose water to ambient temperatures. Evaporation ponds can be used to extract salts, and other chemicals from the water. Evaporation ponds can be used to store water. However, evaporation ponds when not properly maintained can leak contaminants into the environment affecting human and animal health. Moreover, evaporation ponds pose a threat to environmental sustainability because resources such as water, land, and minerals are rapidly used at large scales. Evaporation ponds have been found to increase greenhouse gas emissions and contribute to environmental issues such as the warming of the planet and ocean acidification. Also, as the pond evaporates, the volatile pollutants are carried into the air.

An option is to re-use the produced water by direct injection, environmentally acceptable direct-use of untreated water, or treatment to a government-issued standard before disposal or supply to users. Produced water can be used in waterflooding, which directly injects water into the reservoirs to help force the oil to the product wells, to achieve maximum oil recovery. Whether, the produced water is to be re-used by direct injection, supplied to users, or disposed of, it needs to be treated prior to re-use.

The disclosure also describes a method of using the organophosphorous and/or organosulfurous compounds in combination with one or more other compounds to treat produced water, wastewater, ground water, wastewater and ground water systems, and their filtration systems. The one or more other compounds include such as antimicrobial agents, surfactants, antifoaming agents, preservatives, agents providing scent, solvents, pH adjusters, or a combination of one or more thereof.

In embodiments, the organophosphorous and/or organosulfurous compounds used herein are in a solution buffered to a pH of 4-5. In embodiments, the organophosphorous and/or organosulfurous compounds used herein are in a solution buffered to a pH of 5-10. In embodiments, the organophosphorous and/or organosulfurous compounds are anionic, cationic, or nonionic.

In embodiments, the methods of the use of organophosphorous and/or organosulfurous compounds in combination to treat fouling described herein provide significant benefits to treat a variety of organisms that foul surfaces. In embodiments, the organophosphorous and/or organosulfurous compounds are used in combination with an antimicrobial.

In embodiments, the compositions described herein consist of an antifoam agent. In embodiments, the antifoam agent is silicone based, non-silicone based, and/or polyurethane dispersions. In embodiments, the antifoam agent includes, SE-15, x, and x. SE-15 contains 10% active silicon and non-ionic emulsifiers. In embodiments, the concentration of the antifoam agent is a concentration of between 0.001% to 1%. In embodiments, the solvent is administered at a concentration of 0.001% to 0.01%, 0.01% to 0.05%, 0.05% to 0.1%, 0.1% to 0.5%, or 0.5% to 1.0%.

In embodiments, the disclosure provides a method of the use of organophosphorous and/or organosulfurous compounds in combination with natural and/or synthesized water-borne, oil-borne, or light organic solvent chemical preservatives to increase the durability and resistance of wood, timber, wood structures, or engineered lumber from being destroyed by insects, fungi, other microorganisms, and/or climate and surrounding elements, etc. Application processes include pressure processes, non-pressure processes, such as spraying, soaking, dipping, bathing, brush and spray treatments, steeping, etc., and other processes and treatments.

In embodiments, the compositions described herein remove contaminants and/or improves the removal of contaminants. The contaminants can be in the water, on the surface of water, any wet surface, or on industrial or household surfaces, including apparatuses (such as medical devices), counters, and other hard and soft surfaces. Examples of contaminants include microorganisms (such as algae, bacteria, fungi, and viruses), salt, soil, dirt, suspended solids (such as sand), hydrocarbons (such as oil and fuel), biofilms (such as those formed by bacteria, fungi, algae, extracellular polymeric substances (EPS) or a combination thereof), metals (such as zinc, lead, manganese, iron, and barium), scale deposits (such calcium sulfate, calcium sulfate, and barium sulfate), toxins (such as arsenic and radium), chemicals such as chemical additives injected into the well to facilitate extraction (polymers, carbon dioxide), and a combination thereof. In embodiments, the contaminants can be a floating clump comprising a combination of the exemplary contaminants. In embodiments, the compositions described herein remove contaminants from produced water.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” The transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. In embodiments, lack of a material effect is evidenced by lack of a statistically-significant reduction in the embodiment's ability to perform a function, for example, preventing or treating microbial contamination or fouling.

In addition, unless otherwise indicated, numbers expressing quantities of ingredients, constituents, reaction conditions, and so forth used in the specification and claims are to be understood as being modified by the term “about.” When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±15% of the stated value; ±10% of the stated value; ±5% of the stated value; ±4% of the stated value; ±3% of the stated value; ±2% of the stated value; ±1% of the stated value; or ± any percentage between 1% and 20% of the stated value.

Recitation of ranges of values herein is merely intended to serve as a shorthand method of referring individually to each separate value falling within the range. Unless otherwise indicated herein, each individual value is incorporated into the specification as if it were individually recited herein. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.5, 2.7, 3, 4, 5, 5.1, 5.3, 5.8, and 6. This applies regardless of the breadth of the range. Moreover, any ranges cited herein are inclusive.

All methods described herein can be performed in any suitable order unless otherwise indicated herein or otherwise clearly contradicted by context.

The use of any and all examples, or exemplary language (e.g., “such as”) provided herein is intended merely to better illuminate the claimed subject matter and does not pose a limitation on the scope of claimed subject matter. No language in the specification should be construed as indicating any non-claimed element essential to the practice of the claimed subject matter.

Groupings of alternative elements or embodiments of the claimed subject matter disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

The following exemplary embodiments and examples illustrate exemplary compositions and methods provided herein. These exemplary examples are not intended, nor are they to be construed, as limiting the scope of the disclosure. It will be clear that the methods can be practiced otherwise than as particularly described herein. Numerous modifications and variations are possible in view of the teachings herein and, therefore, are within the scope of the disclosure.

### Exemplary Embodiments

The following are exemplary embodiments:
1. A compound or a composition including one or more organophosphorous and/or organosulfurous compounds, or salts, acids, bases, hydrates, solvates, and/or derivaties thereof in an effective amount for treating produced water.
2. The composition of embodiment 1, wherein the composition prevents the formation of biofilm, prevents fouling, and/or killing of microbes in the produced water.
3. The composition of embodiment 1 or 2, wherein the composition further includes one or more surfactants.
4. The composition of any one of embodiments 1-3, wherein the composition further includes one or more solvents.
5. The composition of any one of embodiments 1-4, wherein the composition further includes one or more antimicrobial agents.
6. The composition of any one of embodiments 1-5, wherein the composition further includes one or more antifoaming agents.
7. The composition of any one of embodiments 1-6, wherein the composition further includes one or more preservatives.
8. The composition of any one of embodiments 1-7, wherein the composition further includes one or more pH adjusters.
9. The composition of any one of embodiments 1-8, wherein the composition further includes one or more agents providing scent.
10. The composition of any one of embodiments 1-9, wherein the one or more organophosphorous or organosulfurous compounds are antibiofilm agents.
11. The composition of any one of claims 1-10, wherein the amount of each component in the composition relative to the total weight of the composition is,
   one or more organophosphorous or organosulfurous compounds: 1 wt % to 90 wt % wt;
   one or more antimicrobial agents: 0 wt % to 90 wt %;
   one or more antifoaming agents: 0 wt % to 2 wt %;
   one or more surfactants: 0 wt % to 90 wt %;
   one or more preservatives: 0 wt % to 10 wt %;
   one or more pH adjusters: 0 wt % to 2 wt %. and
   one or more solvents: quantity sufficient (Q.S.) to 100% solution.
12. The compound or composition of any one of embodiments 1-11, wherein the compound or composition is an antibiofilm agent, an antifouling agent, and/or an antimicrobial agent.
13. The compound or composition of embodiment 12, wherein the antimicrobial agent includes an antifungal agent, an antiviral agent, an antibacterial agent, an antiprotozoal agent, or a combination thereof.
14. A method of treating produced water, wherein the method includes applying the compound or composition of any one of claims 1-13 to the produced water.
15. A method of treating contaminants in produced water, wherein the method includes contacting the contaminants in the produced water with the compound or composition of any one of embodiments 1-13.
16. The method of embodiment 15, wherein treating the contaminants includes killing and/or preventing the growth of the contaminants.
17. The compound, composition, or method of any one of embodiments 1-16, wherein the organophosphorous or organosulfurous compounds include sodium dodecylbenzenesulfonate (SDBS), sodium dodecyl sulfate (SDS), 4-Dodecylbenzenesulfonic acid (DBSA), butyl phosphoramidate (BPA), (4-aminophenetyl) dimethylphosphine oxide (APDMPO), dibutyl phosphate (DBP), n-butyl phosphate, or dibutyl phosphite (DBPT).
18. The compound, composition, or method of any one of embodiments 1-17, wherein the compound is an organophosphorous and/or organosulfurous compound of Formula I, Formula II, Formula IIA, Formula IIB, Formula IIC, Formula III, Formula IV, or Formula V as described herein, or a salt, acid, base, hydrate, solvate thereof, or a derivative thereof.
19. The compound, composition, or method of any one of embodiments 1-18, wherein the composition includes one or more derivatives, salts, acids, bases, hydrates, or solvates of the one or more organophosphorous and/or organosulfurous compounds of Formula I, Formula II, Formula IIA, Formula IIB, Formula IIC, Formula III, Formula IV, or Formula V described herein.
20. The compound, composition, or method of any one of embodiments 1-19, wherein the produced water is from an oil field.
21. The compound, composition, or method of any one of embodiments 1-20, wherein the produced water includes contaminants and optionally wherein the contaminants comprise microorganisms, salt, soil, dirt, suspended solids, hydrocarbons, biofilms, metals, scale deposits, toxins, and chemicals.
22. The compound, composition, or method of any one of embodiments 1-21, wherein the compound, composition, or method treats the one or more contaminants in the produced water by killing the contaminants, preventing the growth of the contaminants, and/or removing the contaminants.

### Examples

The following Examples are illustrative of specific embodiments of the disclosure, and various uses thereof. They are set forth for explanatory illustration only and are not to be construed as limiting on the disclosure in any way.

A primary objective of the present invention is to provide a cleaner treatment, that has superior efficacy by incorporating an antibiofilm or antifouling compound. The antibiofilm molecules are hereby referred to as sodium dodecylbenzenesulfonate (SDBS), sodium dodecyl sulfate (SDS), sodium 2-ethylhexylsulfate (SEHS), 4-Dodecylbenzenesulfonic acid (DBSA), butyl acid phosphate (BAP), dibutyl phosphate (DBP), dibutyl phosphite (DBPT), Bis(2,2,2-trifluoroethyl) phosphite, Diethyl(Bromodifluoromethyl)phosphonate, synthetic butyl phosphoramidate BPA and natural components, including but not limited to BPA, other organic acids, and H2O2 produced by lactic acid producing bacteria, and the marine bacteria A. viridans.

The formula set forth below as Example 1 is an example of a composition of an undiluted treatment. Example 1 can be made by dilution of a concentrate with water. The concentrate comprises on a weight basis: from about 1 to about 90% of an antibiofilm agent, from 0 to about 80% of a second antibiofilm agent, from 0 to about 80% of a surfactant, from 0 to about 90% of an antimicrobial, from 0 to about 90% of a second antimicrobial, from 0 to about 90% of a third antimicrobial, from 0 to about 10% of a preservative, from 0 to about 2% of an antifoam, from 0 to about 10% of a pH adjuster, and a solvent. The dilution may be 1:5, 1:10, 1:20, 1:30, 1:40, 1:50, 1:60, 1:70, 1:80, 1:90, 1:100, 1:1,000, 1:10,000, 1:100,000.

Example 1

| Ingredient | Wt. % |
|---|---|
| Antibiofilm agent | 0-90 |
| Surfactant | 0-80 |
| Antimicrobial 1 | 0-90 |
| Antimicrobial 2 | 0-90 |
| Preservative | 0-10 |
| Antifoam | 0-2 |
| pH adjuster | 0-10 |
| Solvent | Q.S.¹ |

¹Quantity sufficient to make 100% solution

### Test Methods

Since the antimicrobial and antibiofilm activity is an important indicator of the potential value of the treatment, the example above was subject to the standard antimicrobial and antibiofilm test methods. Typical bacteria known to be related to the contamination of water were tested. A mixed microbial inoculum containing sulfate reducing bacteria (SRB) was isolated from oilfield produced water.

To determine biofilm removal, the minimum biofilm eradicating concentration (MBEC) assay was performed according to the ASTM standard (ASTM E2799-12; Standard Test Method for Testing Disinfectant Efficacy against Pseudomonas aeruginosa Biofilm using the MBEC Assay) with the following modifications. SRB Modified Postgate B Media (2.5% salinity, Intertek, Houston, TX) 160 μL and 40 μL inoculum (produced water containing SRB) was added to wells in a 96 well plate containing pegs and incubated 96 hrs to allow for biofilm growth on the pegs. After 96 hr, 50 μL antimicrobial solutions (THPS, glutaraldehyde, sodium dodecylbenzene sulfonate, and 4-dodecylbenzenesulfonic acid) or sterile water (controls) were added to the wells containing the pegs. After a contact time of 30 min, pegs were removed and transferred to microcentrifuge tubes containing 1 mL of deoxygenated water. Microcentrifuge tubes were sonicated to remove and disaggregate biofilm. The 1 mL contents were injected into SRB media and serially diluted to 10-8, incubated anaerobically, and measured at 28 days according to positive/negative. Results were reported as growth/no growth.

To determine biofilm inhibition, the minimum biofilm inhibiting concentration (MBIC) was performed according to the ASTM standard (ASTM E2799-12) with the following modifications. SRB Modified Postgate B Media (2.5% salinity, Intertek, Houston, TX) 160 μL, 40 μL inoculum (produced water containing SRB), and 50 μL antimicrobial solutions (THPS, glutaraldehyde, sodium dodecylbenzene sulfonate, and 4-Dodecylbenzenesulfonic acid) or sterile water (controls) were added to wells in a 96 well plate containing pegs to allow for biofilm growth. After 24 hr, 48 hr, and 72 hrs of anaerobic incubation, pegs were removed, transferred to microcentrifuge tubes containing 1 mL of deoxygenated water, and sonicated to remove and disaggregate biofilm. The 1 mL contents were injected into SRB media and serially diluted to

10-8, incubated anaerobically, and measured at 28 days according to the most probable number (MPN) method and measured as presence/absence.

The antibiofilm test results for the compounds are presented in Tables 13 and 14.

TABLE 13
Antibiofilm results of treatment chemistries against
mixed environmental SRBs in produced water.

| | MBIC | | | MBEC |
|---|---|---|---|---|
| | 24-hr | 48-hr | 72-hr | (removal of 96-hr |
| | (biofilm | (biofilm | (biofilm | biofilm; 30 min |
| | prevention) | prevention) | prevention) | contact time) |
| | (ppm) | (ppm) | (ppm) | (ppm) |
| SDBS | 10 | 10 | 50 | 10 |
| DBSA | 10 | 10 | 25 | 10 |
| Glut | 10 | 10 | 10 | 50 |
| THPS | 10 | 50 | 50 | 75 |

TABLE 14
Antibiofilm results of treatment chemistries
against Pseudomonas aeruginosa.

| | MBEC |
|---|---|
| | (removal of 48-hr |
| | biofilm) |
| | (ppm) |
| BAP | ≤47 |
| DBPT | ≤94 |

The subject matter described above is provided by way of illustration only and should not be construed as limiting. Various modifications and changes may be made to the subject matter described herein without following the example embodiments and applications illustrated and described, and without departing from the true spirit and scope of the present disclosure, which is set forth in the following claims.

All publications, patents and patent applications cited in this specification are incorporated herein by reference in their entireties as if each individual publication, patent, or patent application were specifically and individually indicated to be incorporated by reference. While the foregoing has been described in terms of various embodiments, the skilled artisan will appreciate that various modifications, substitutions, omissions, and changes may be made without departing from the spirit thereof.

1. A composition comprising one or more organophosphorous and/or organosulfurous compounds, or salts, acids, bases, hydrates, and/or solvates thereof in an effective amount for treating produced water, wherein the one or more organophosphorous and/or organosulfurous compounds have the structure of 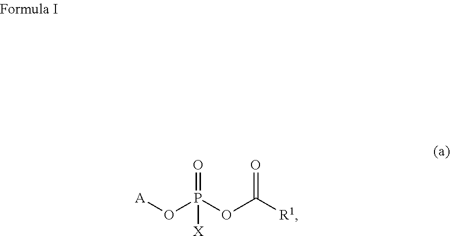
wherein A is C_{H-10} hydrocarbyl or C₁₋₁₀ hydrocarbyl substituted with R¹; X is NHR, NHOR, NHCOR, NHOCOR, or OR; and R is H or C₁₋₁₀ hydrocarbyl;
R¹ is hydrogen, halogen, cyano, OH, C₁₋₆ hydrocarbyl, C₁₋₆ alkoxy, SOR², SO₂R², SO₂NR³R⁴COR², CO₂R², CONR³R⁴, NR³R⁴, NR³COR⁴, NR³SO₂R⁴, NR³CO₂R⁴, NR³CONR⁴, OCOR², or phosphonic acid, wherein each of C₁₋₆ hydrocarbyl, C₁₋₆ alkoxy, SOR², SO₂R², SO₂NR³R⁴, COR², CO₂R², CONR³R⁴, NR³R⁴, NR³COR⁴, NR³SO₂R⁴, NR³CO₂R⁴, NR³CONR⁴, or OCOR², can be optionally substituted with halo, amino, hydroxyl, C₁₋₆ hydrocarbyl, C₁₋₆ alkoxy, cyano, or phosphonic acid; and
R², R³, and R⁴ are independently selected from hydrogen or C₁₋₆ hydrocarbyl, wherein each of the C₁₋₆ hydrocarbyls can be optionally substituted with halo, amino, hydroxyl,
C₁₋₆ alkoxy, cyano, or phosphonic acid; 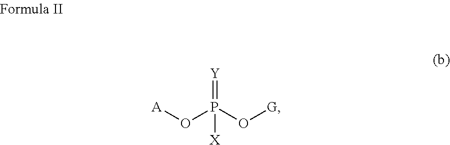
wherein A is R; Y is O or S; X is NH₂, OH, or OR; and G is R, wherein R is C₁₋₁₆ hydrocarbyl; 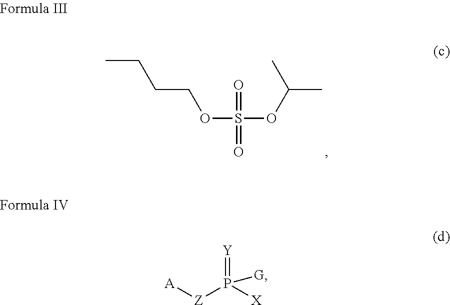
wherein A is H, C₁₋₁₆ hydrocarbyl or C₁₋₁₆ hydrocarbyl substituted with R¹; Z is O or a bond; Y is O; G is OH, H, C₁₋₆—COO-alkyl, O—C₁₋₁₆ alkyl, C₁₋₁₆ hydrocarbyl, R¹ substituted C₁₋₁₆ hydrocarbyl, CH₂NHCH₂COOH, or O-aryl; X is H, CN, —NHR, —NHOR, —NHOCOR, C₁₋₁₀ hydrocarbyl, R¹ substituted C₁₋₁₀ hydrocarbyl, or OR; and R is H, C₁₋₁₀ hydrocarbyl, or R¹ substituted C₁₋₁₀ hydrocarbyl;
R¹ is halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, or phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³, and R⁴ are independently selected from hydrogen, C₁₋₆ hydrocarbyl, in which each of the C₁₋₆ hydrocarbyls can be optionally substituted with halo, amino, hydroxyl, C₁₋₆ alkoxy, cyano, or phosphonic acid; or 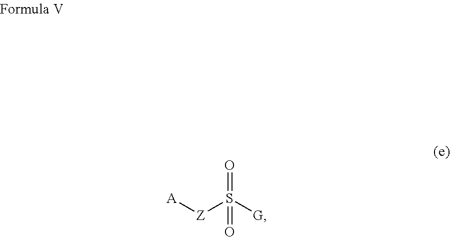
wherein A is H, C₁₋₂₀ hydrocarbyl, alkylaryl, or C₁₋₂₀ hydrocarbyl substituted with R¹; Z is O or a bond; G is OH, H, C₁₋₆—COO-alkyl, O—C₁₋₆ alkyl, C₁₋₁₆ hydrocarbyl, R¹ substituted C₁₋₁₆ hydrocarbyl, CH₂NHCH₂COOH, or O-aryl;
R¹ is halogen, cyano, OH, C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, or phosphonic acid, wherein each of C₁₋₆ hydrocarbyl, C₁₋₆ alkoxy, SOR², SO₂R², SO₂NR³R⁴, CONR³R⁴, NR³R⁴, NR³COR⁴, NR³SO₂R⁴, NR³CO₂R⁴, NR³CONR⁴, can be optionally substituted with halo, amino, hydroxyl, C₁₋₆ hydrocarbyl, C₁₋₆ alkoxy, cyano, or phosphonic acid; and
R², R³, and R⁴ are independently selected from hydrogen, C₁₋₆ hydrocarbyl, in which each of the C₁₋₆ hydrocarbyls can be optionally substituted with halo, amino, hydroxyl, C₁₋₆ alkoxy, cyano, or phosphonic acid.

2. The composition of claim 1, wherein the one or more organophosphorous and/or organosulfurous compounds have the structure shown in Table 1, 2, 3, 4, 5, 6, 7, 8, 9, 10, 11, or 12 or have the structure of

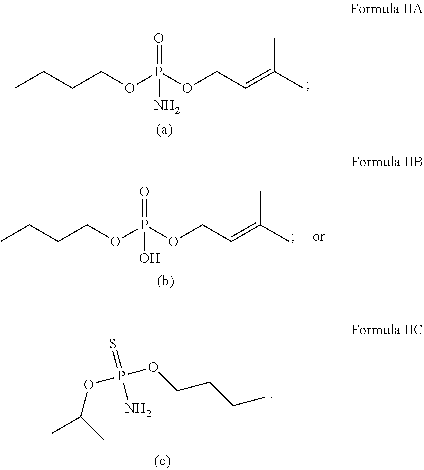

3. The composition of claim 1, wherein the composition prevents formation of biofilm, prevent fouling, and/or kills microbes in the produced water.

4. The composition of claim 1, wherein the composition further comprises one or more surfactants.

5. The composition of claim 1, wherein the composition further comprises one or more solvents.

6. The composition of claim 1, wherein the composition further comprises one or more antimicrobial agents.

7. The composition of claim 1, wherein the composition further comprises one or more antifoaming agents.

8. The composition of claim 1, wherein the composition further comprises one or more preservatives.

9. The composition of claim 1, wherein the composition further comprises one or more pH adjusters.

10. The composition of claim 1, wherein the composition further comprises one or more agents providing scent.

11. The composition of claim 1, wherein the one or more organophosphorous or organosulfurous compounds are antibiofilm agents.

12. The composition-er-method of claim 1, wherein the organophosphorous or organosulfurous compounds comprise sodium dodecylbenzenesulfonate (SDBS), sodium dodecyl sulfate (SDS), 4-Dodecylbenzenesulfonic acid (DBSA), butyl phosphoramidate (BPA), (4-aminophenetyl) dimethylphosphine oxide (APDMPO), dibutyl phosphate (DBP), n-butyl phosphate, or dibutyl phosphite (DBPT).

13. The composition of claim 1, wherein the composition is an antibiofilm agent, an antifouling agent, and/or an antimicrobial agent.

14. The composition of claim 13, wherein the antimicrobial agent comprises an antifungal agent, an antiviral agent, an antibacterial agent, an antiprotozoal agent, or a combination thereof.

15. The composition of claim 13, wherein the amount of each component in the composition relative to the total weight of the composition is,
one or more organophosphorous or organosulfurous compounds: 1 wt % to 90 wt %;
one or more antimicrobial agents: 0 wt % to 90 wt %;
one or more antifoaming agents: 0 wt % to 2 wt %;
one or more surfactants: 0 wt % to 90 wt %;
one or more preservatives: 0 wt % to 10 wt %;
one or more pH adjusters: 0 wt % to 2; and
one or more solvents: quantity sufficient (Q.S.) to 100% solution.

16. The composition of claim 13, wherein the produced water comprises contaminants and optionally wherein the contaminants comprise microorganisms, salt, soil, dirt, suspended solids, hydrocarbons, biofilms, metals, scale deposits, toxins, and chemicals.

17. A method of treating produced water, wherein the method comprises applying the composition of claim 13 to the produced water.

18. A method of treating one or more contaminants in produced water, wherein the method comprises contacting the contaminants in the produced water with the composition of claim 13.

19. The method of claim 18, wherein the method further comprises treating one or more contaminants in the produced water by killing the contaminants, preventing the growth of the contaminants, and/or removing the contaminants.

20. The method of claim 19, wherein the contaminants comprise microorganisms, salt, soil, dirt, suspended solids, hydrocarbons, biofilms, metals, scale deposits, toxins, and chemicals.

21. The method of claim 18, wherein the produced water is from an oilfield.
